(19) United States
(12) Patent Application Publication
(10) Pub. No.: US 2009/0037529 A1
(43) Pub. Date: Feb. 5, 2009

(54) Data sharing in a group of peers with limited resources

(75) Inventors: Gilad Armon-Kest, Tel-Aviv (IL); Sarit Kraus, Givat Shmuel (IL); Gal A. Kaminka, Kfar-Saba (IL)

Correspondence Address: MARTIN D. MOYNIHAN d/b/a PRTSI, INC., P.O. BOX 16446, ARLINGTON, VA, 22215, US

(73) Assignee: Samsung Electronics Co., Ltd., Gyeonggi-do (KR)

(21) Appl. No.: 11/882,294

(22) Filed: Jul. 31, 2007

(51) Int. Cl. G06F 15/16

(52) U.S. Cl. 709/204

(57) ABSTRACT

A method for cooperation between mobile devices peers representing social relations of the owners of the peers, comprising (a) providing a plurality of peers in a network and cooperating in a manner which utilizes resources of the devices responsive to the social relations.

### RELATED APPLICATIONS

The present application relates to U.S. patent application Ser. No. 11/703,758 filed Feb. 8, 2007 and entitled “SEARCHING IN PEER-TO-PEER NETWORKS”, the disclosure of which is incorporated herein by reference.

### FIELD OF THE INVENTION

The invention relates to data sharing in a peer-to-peer (P2P) organization over a communication system. Some embodiments relate to sharing data such as pictures between mobile phones in a cellular communication system.

### BACKGROUND OF THE INVENTION

Data sharing between peers (P2P) is known in the art, and various techniques and algorithms have been devised for that purpose. The introduction of applications such as Napster, Gnutella, BitTorrent and their likes raised further interest in the field. These applications, while trying to consider bandwidth sharing, typically use powerful computers with large memories, internal and peripheral (e.g. disks) over a high throughput broadband communications.

Some work was published with respect a relatively lower end communications, such as wireless portable computers (WiFi) or Bluetooth devices. For example, a method to find a linkage topology (On Topology Control of Wireless Peer-to-Peer File Sharing Networks: Energy Efficiency, Fairness and Incentive, A. K Leung and Y Kwok, WoWMoM'05, IEEE 2005) or load reduction while saving battery (SPIN-IT: A Data Centric Routing Protocol for Image Retrieval in Wireless Networks, E. Woodrow and W. Heinzelman, Proc. International Conference on Image Processing (ICIP '02), September 2002), the disclosures of which are incorporated herein by reference.

### SUMMARY OF THE INVENTION

A broad aspect of some embodiments of the invention relates to data sharing interactions between peers represented by their cellular or wireless phones and/or handsets and/or portable devices and/or mobile devices—hereinafter phones or cellular phones (or telephones).

Cellular phones are frequently characterized by one or more of (a) limited resources, such as memory, energy and computing power, (b) communications cost, for either or both of the sending and receiving parties, and (c) limited communications bandwidth. Another typical characteristic is the dynamics of the system as units may randomly connect or disconnect.

In exemplary embodiments of the invention, sharing data comprises a significant load on a phone resources. Optionally the load is large relative to, or approximately about, the load of other operations of the phone. For example, sending data may consume a significant share of the available bandwidth and/or processing power, or battery capacity of the phone. Optionally, the cost of data sharing comprises a significant cost relative to the costs of other operations of the phone. Optionally the cost is large relative to, or approximately about, the cost of other operations of the phone. for example, cost of data sending may incur a significant communications cost relative to other operations such SMS or normal talks.

In exemplary embodiments of the invention, the phones interact for data sharing within a group. Optionally, the phones comprise a group characterized by identifications (ID) unique to each phone and accessible by the phones. Optionally, the ID is a phone number, or name of a phone, or a phone code, or name or part of name of the phone owner, or a nickname of the phone owner, or the phone SIM number or the phone IP number, or MAC number of a device.

In exemplary embodiments of the invention, a group comprises phones that represent persons with whom a phone owner has social relations, such as family, friends, work colleagues, business customers, or an organizations members. Optionally, the phones represent their owners and treated, at least partially if they were the respective owners.

In exemplary embodiments of the invention, a group is formed as one phone contacts another phone for data sharing and consequently one or both phones registers in the phone memory the other one as member of a group. Optionally, a phone notifies another phone about other phones as members of a group.

Optionally or alternatively, a group may be defined by other methods, such as registering a phone in a server or at the cellular company or other service such as the server of the manufacturer of the device.

In exemplary embodiments of the invention, a phone in the group can contact another phone in the group by using the ID, for example, phone number or IP. Optionally, the ID is used to identify the contact method, for example, using a name to find the respective phone number. Optionally, a phone or server serves as a relay to another phone, for example, providing a contact number of another phone.

An aspect of some embodiments of the invention relates to cooperation between mobile devices peers (e.g. phones) representing social relations of the owners of the peers. comprising:

In exemplary embodiments of the invention, the cooperation comprises utilizing resources of the devices responsive to the social relations. Optionally, the cooperation comprises data sharing and/or interacting for data sharing.

In exemplary embodiments of the invention, a phone represents the phone owner by a model of at least some of the social relations of the owner with respect to other owners (that are represented by their respective models). Optionally, the model comprises variables representing at least part of the social relations of the phone owner, and operations for data sharing on behalf of the phone owner according to the variables. Optionally, a phone model interacts for data sharing with a model of one or more phones.

In exemplary embodiments of the invention, the model is implemented as a program executing on the phone, the program referred to as an ‘agent’.

In exemplary embodiments of the invention, an expression of the social relations of one peer toward another peer comprises a degree of will or consent (or oppositely, a degree of decline or refusal) to interact in data sharing. Optionally, the degree of will or refusal (‘willingness’) is responsive to the self interest of the peer and/or the peer owner. Optionally, the self interest comprises possible future gains such as maintaining the group activity and maintaining opportunities in data sharing or other benefits. Optionally or alternatively, the willingness is affected by interests of other parties such as a service provider or the device manufacturer.

An aspect of some embodiments of the invention relates to data sharing between mobile devices peers (phones) representing social relations of the owners of the peers, responsive to a degree of fairness.

In exemplary embodiments of the invention, a peer tries to achieve cooperation with other peers by attempting to maintain a fair interaction. Optionally, the fair interaction is reflected by a fairness degree of a peer towards another peer. For example, a peer cooperates with other peers (increasing the fairness degree of the other peers towards the peer) so that the other peers will eventually cooperate with the peer, rather than deny the peer from the benefits of data sharing.

Fairness, in this context, does not necessarily mean equality of contributions and benefits, but, rather, a degree by which a peer considers itself as being treated fairly. Optionally, when a peer perceives, or calculates, that it was treated fairly by another peer or peers it may consent to grant data to that peer or peers. Optionally, in judging or evaluating a fairness degree with respect to another or other peers, a peer takes into account the social relations with that peer. Optionally, other factors are considered such as resources utilization, type and amount of data transferred, or costs or revenues.

In exemplary embodiments of the invention, an agent maintains on behalf of its peer a fairness degree with respect to one or more peers. Optionally, the fairness degree is modified responsive to cooperation in data sharing of one or more peers.

An aspect of some embodiments of the invention relates to data sharing between mobile devices peers (phones) representing social relations of the owners of the peers, responsive to a degree of willingness.

In exemplary embodiments of the invention, a willingness degree (or refusal or reluctance) comprises a degree of a peer agreement or compliance to cooperate with another peer. Optionally, the willingness degree comprises an agreement or compliance to cooperate even beyond (or below) what a peer perceives that it is entitled by fairness. For example, a peer may contribute data to a peer which did not ever provided anything (e.g. in order to promote sharing), or may decline to provide data to a peer that contributed important data (e.g. in order to preserve battery).

Accordingly, a willingness degree may express more than just a fair interaction or data sharing.

In exemplary embodiments of the invention, an agent maintains on behalf of its peer a willingness degree with respect to one or more peers. Optionally, the willingness degree is modified responsive to cooperation in data sharing of one or more peers.

An aspect of some embodiments of the invention relates to data sharing between mobile devices peers (phones) representing social relations of the owners of the peers, responsive to a of bookkeeping of social relations accounts.

In exemplary embodiments of the invention, the bookkeeping comprises maintaining and/or updating a ‘social account’ of a peer respective to one or more peers. Optionally, the update is responsive to data sharing between the peers. Optionally, the social account comprises parameters (constants and/or variable) reflecting social relations and/or attitudes for cooperation of a peer towards one or more peers. Optionally, the parameters comprise a willingness and/or fairness degree respective to one or more peers or a group or sub-group of peers. Optionally, other parameters are maintained, for example, hierarchy of a peer relative to one or more peers, past data sharing with one or more peers, load on the device, resources of a device, cost of data sharing data, the volume and quality of the data obtained or provided or gained revenues. Optionally, the social account is consulted to determine the data sharing activities appropriate towards other peers. For example, the account is consulted to determine which peers to contact, how to contact them and what data to request, or other interactions such querying their willingness for the peer. Optionally, the bookkeeping comprises a tradeoff between benefits and contribution, past and/or anticipated, while attending to the self interests of the peer.

In exemplary embodiments of the invention, the social account and its maintenance comprise a part of the peer model, and optionally implemented by the peer agent.

In exemplary embodiments of the invention, data sharing comprises a performing a search. Optionally, a search comprises determination of one or more candidate peers according to the social account respective to the one or more peers (e.g. the willingness degree or fairness degree of a candidate peer towards the peer), and requesting data from at least one of the candidate peers. Optionally, the request comprises firstly a query if the candidate has the data and waiting for a response; if a positive response is obtained within a certain time, the peer requests the data from the positively responding candidate. Optionally, the social accounts of both the requesting peer and/or the candidate peers with respect to each other is modified responsive to the search and/or sharing. For example, when a candidate provides data to the peer the peer increases the willingness (and/or fairness) degree towards the candidate, and/or the candidate reduces the willingness (and/or fairness) degree towards the requesting peer. Optionally, the search is regulated (or limited) by the costs the search incurring either to the requesting peer or the candidate peer.

In exemplary embodiments of the invention, the shared data comprises any type of object. For example, text, images, video, sound or combination thereof. Optionally, the data comprises auxiliary information such as in tags or other information characterizing the data, at least partially.

In exemplary embodiments of the invention, the group comprises devices having some of the characteristics of a cellular phone such as limited resources, and/or sharing data of significant amount relative to their resources. Optionally, the group comprises other devices such as wireless and/or cellular handsets or computers.

An exemplary embodiment of the invention comprises cooperation between mobile devices peers representing social relations of the owners of the peers, comprising:
(a) providing a plurality of peers in a network; and
(b) cooperating in a manner which utilizes resources of the devices responsive to the social relations.

Optionally, cooperation comprises data sharing or interaction for data sharing. Optionally, the social relations comprise symmetric or hierarchical relations with respect to one or more peers. Optionally, the social relations comprise one or both of static and dynamic relations with respect to one or more peers.

An exemplary embodiment of the invention comprises representing social relations comprises modeling at least part of the social relation or interaction or cooperation for data sharing. Optionally, the model comprises at least one or more of rules, parameters or actions affecting the cooperation or data sharing. Optionally, modeling is responsive to the social relations of the peers owners. Optionally, the one or more parameters represent at least a fairness degree or a willingness degree to provide data to one or more peers or to request data from one or more peers. Optionally, the one or more parameters represent a social hierarchy respective to one or more peers. Optionally, the fairness degree or the willingness degree is responsive to the social hierarchy degree with respect to one or more peers. Optionally, at least one of the one or more parameters is modified responsive to the data sharing or cooperation.

In an exemplary embodiment of the invention comprises the willingness degree or fairness degree comprises an estimated willingness degree or fairness degree of one or more peers to provide data to the peer. Optionally, the willingness degree or fairness degree is obtained from one or more peers.

In an exemplary embodiment of the invention the fairness degree or willingness degree of a peer respective to one or more peers is adapted to achieve cooperation between the peers.

In an exemplary embodiment of the invention one or more parameters of a first peer model pertaining to a second peer are grouped as a social account of the first peer with respect to the second peer. Optionally, setting at least one of said parameters is by a owner of a device. Optionally, setting at least one of said parameters is by the peer model.

An exemplary embodiment of the invention comprises modifying the modeled social relations responsive to a data sharing or cooperation between the peers. Optionally, modifying comprises modifying at least one of the rules or parameters or actions. Optionally, the modification is responsive to at least one of receiving data, providing data, amount of received or provided data, the merits of data received or provided data, resources utilization in providing data, costs of providing data, revenues obtained in providing data, available resources when providing data or providing information about the data. Optionally, the data merits are responsive to at least one of the data volume, importance, abundance, popularity, distribution among peers, sharing frequency or count, date or age, age rating, contents, or type of the data.

In an exemplary embodiment of the invention the model is implemented, at least partially, by a computerized agent. Optionally, the agent comprises a program. Optionally, the agent comprises at least one of memory, hardware, firmware or processor of the device. Optionally, the agent comprises at least one of add-on memory, hardware or firmware or processor. Optionally, the agent initiates or affects communications of a device with one or more devices.

An exemplary embodiment of the invention comprises consuming resources of a peer device that is larger than, or approximately about, the load of other operations of the device. Optionally, the resources of the device comprise least one of memory, energy, computing power, bandwidth or communications costs. Optionally, a mobile device comprises a cellular phone or cellular handset or wireless handset or a cellular component or a wireless component.

In an exemplary embodiment of the invention the peers comprise a group characterized by identifications unique to each peer and shared by the peers. Optionally, a first peer stores the identification of a second peer in the first peer memory or in another device accessible by the first peer. Optionally, a peer identification is used to contact the respective peer by another peer. Optionally, each peer in the group can contact all other peers the group. Optionally, the identification is one of a phone number, or name of a peer, or a peer code, or name or part of name of the peer owner, or a nickname of the peer owner, or the peer SIM number or the peer IP number, or MAC number of a device.

In an exemplary embodiment of the invention data is shared with a first peer responsive to a search by the first peer, comprising:

(a) determining one or more candidate peers according to the social account of the first peer respective to the candidate peers; and

(b) requesting data from at least one of the candidate peers.

Optionally, determining comprises determining peers according to the willingness degree or fairness degree of a candidate peer to share data with the first peer. Optionally, the candidate peers are limited according to at least one parameter comprised in the first peer model or agent. Optionally, requesting data comprises:

(a) querying at least one of the candidate peers whether the candidate peer has the data;

(b) waiting for a response from at least one of the candidate peers;

(c) requesting the data from a candidate peer that responded that it has the data; and

(d) receiving the data from at least one of the candidate peers;

Optionally, having the data comprises possessing the data, or having access to the data, or having the location of the data. Optionally, requesting data comprises requesting a location of the data. Optionally, querying or requesting the at least one the candidate peer is determined according to a cost of a query or request. Optionally, the cost is responsive to the number of messages sent to query about or request the data. Optionally, waiting is limited according to at least one parameter comprised in the first peer model or agent. Optionally, querying a candidate peer comprises increasing the willingness degree or the fairness degree of the first peer with respect to the candidate peer. Optionally, querying a candidate peer comprises decreasing the willingness degree or the fairness degree of the candidate peer with respect to the first peer. Optionally, receiving the data comprises increasing the willingness degree or the fairness degree of the first peer with respect to the at least one candidate peer. Optionally, receiving the data comprises decreasing the willingness degree or the fairness degree of the at least one candidate peer with respect to the first peer. Optionally, increasing or decreasing is responsive to one or more of the size of the data, or merits of the data, or resources utilization in providing the data, or costs of providing data, or revenues obtained in providing data, or available resources in providing data. Optionally, receiving the data is limited by a time period according to at least one parameter comprised in the first peer model or agent.

An exemplary embodiment of the invention comprises modeling cooperating mobile devices peers, comprising:

(a) providing a plurality of peers in a network; and

(b) modeling the cooperation of one peer by another peer.

Optionally, modeling comprises at least one or more of rules, parameters or actions affecting the cooperation.

### BRIEF DESCRIPTION OF THE DRAWINGS

Non-limiting examples of embodiments of the present invention are described with reference to figures listed below. Identical or equivalent structures, elements or parts that appear in some figures are labeled with the same numerals.

FIG. 1 schematically illustrates a peer-to-peer network comprising a group of connected peers represented by a plurality of cellular phones in a network, in accordance with an exemplary embodiment of the invention;

FIG. 2 schematically illustrates a group of peers comprising an intersection of phone numbers in phones directories, in accordance with an exemplary embodiment of the invention;

FIG. 3 schematically illustrates a contact of one peer to another peer via a relay peer, in accordance with an exemplary embodiment of the invention;

FIG. 4 illustrates a flowchart of a skeleton of a search strategy, in accordance with an exemplary embodiment of the invention;

FIG. 5 schematically illustrates a time-line of events in an interaction for data sharing between peers, in accordance with an exemplary embodiment of the invention;

FIG. 6 illustrates the performance of FAST, CHEAP and RAND searches in terms of the number of query messages with respect to the peers group size, in accordance with an exemplary embodiment of the invention;

FIG. 7 illustrates a fairness performance of FAST, CHEAP and RAND searches in terms of a distribution of peers that shared data objects with respect to the peers group size, in accordance with an exemplary embodiment of the invention;

FIG. 8 illustrates time performance of FAST, CHEAP and RAND searches in terms of object retrieve time with respect to the peer group size, in accordance with an exemplary embodiment of the invention;

FIG. 9 illustrates the performance of FAST, CHEAP and RAND searches in terms of the number of query messages with respect to the data object size, in accordance with an exemplary embodiment of the invention;

FIG. 10 illustrates the performance of FAST, CHEAP and RAND searches in terms of object retrieve time with respect to the data object size, in accordance with an exemplary embodiment of the invention; and

FIG. 11 illustrates the performance of FAST, CHEAP and RAND searches in terms of object retrieve time with respect to the data object size similarly to FIG. 10 but with a smaller group of peers, in accordance with an exemplary embodiment of the invention.

### DETAILED DESCRIPTION OF EMBODIMENTS OF THE INVENTION

For clarity and streamlining some of the following descriptions, peers sharing data will be tagged. The tagging is according to the actual or prospective role of a peer in the data sharing interaction. A peer requesting or querying about data will be tagged as an ‘applicant’, and a peer potentially or actually providing data will be tagged as a ‘donor’. These terms do not suggest any inherent property or quality of any peer, but only denote the role they temporarily play in an interaction. An applicant may be a donor in another interaction and vice versa, or an applicant may be a donor in a concurrent interaction with another applicant or vice versa. Generally, the peers are substantially equal in terms of potential roles, yet, not necessarily to the same extent.

For streamlining some of the following descriptions, unless otherwise specified, a phone and/or its human user represented by the phone will be denoted as ‘peer’.

The non-limiting headings that follow are intended for clarity only.

### Cellular Telephones (and Other Devices)

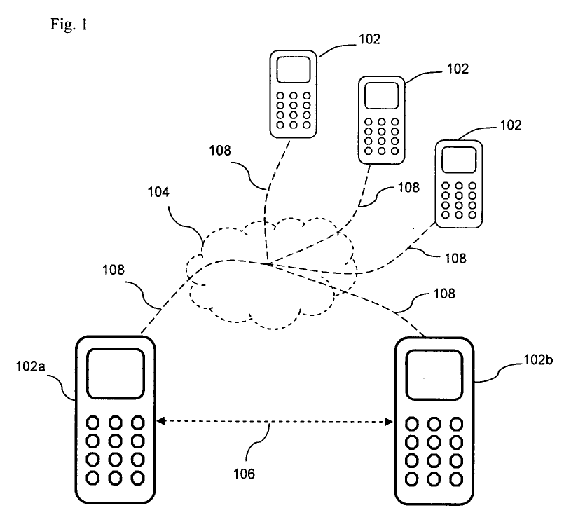

FIG. 1 schematically illustrates a peer-to-peer network comprising a group of connected peers represented by a plurality of cellular phones 102 in a cellular network 104, in accordance with an exemplary embodiment of the invention.

In exemplary embodiments of the invention, phones 102 are owned by persons, wherein phones 102 represent their owners. Optionally, phones 102 represent social relations of their owner. Optionally, the representation comprises modeling, at least partially, the owners social relations. Optionally or alternatively, the phones take part in data sharing interaction on behalf of the peers responsive to the social relations of the peers.

In exemplary embodiments of the invention, other cellular devices are used such as PDA (personal data assistant) or other handsets or laptop computers with cellular adapter, or any equipment with a cellular or wireless component for cellular or wireless communication. Optionally other portable devices over wireless network are used. Optionally, devices with at least some of the characteristics of cellular phones (e.g. battery, limited resources) are of particular, though non-limiting, interest.

In exemplary embodiments of the invention the connection and data transfer between peers is carried out by techniques such as TCP/IP, Bluetooth, SMS, MMS, or other methods for transferring data between cellular and/or wireless devices.

In exemplary embodiments of the invention, the type of the connection and data transfer may affect the speed and/or costs of data sharing. For example, using TCP/IP may incur no, or negligible, marginal (in addition to a fixed or connection cost) transfer costs, whereas SMS/MMS may incur costs proportional to the amount of the transferred data and optionally connection time.

In the discussion below, unless otherwise specified, the term ‘peer’ implies a cellular phone (or other wireless device) representing the respective owner and interacting on the owner behalf, and reference to persons, unless otherwise specified, is to illustrate some relations represented by their phones 102.

### Social Relations

In exemplary embodiments of the invention, social relations between a peer and one or more peers affect cooperation between the peers, such as cooperation in data sharing. Optionally, the peers belong to a group having a certain characteristic or defined by some mechanism, such as common phone numbers (see later).

In exemplary embodiments of the invention, the social relations between a peer and one or more peers comprise ‘symmetric’ relations, that is, the peers are of equal or about the same hierarchy, such as students in a class or members of a club.

In exemplary embodiments of the invention, the social relations between a peer and one or more peers comprise ‘asymmetric’ relations, i.e. hierarchical relations, where one peer is more privileged than another, such as parents and children or managers and workers.

In exemplary embodiments of the invention, the social relations between a peer and one or more peers comprise ‘static’ relations, that is, the peers maintain their social relations for a considerable time period, such as family members.

In exemplary embodiments of the invention, the social relations between a peer and one or more peers comprise ‘dynamic’ relations, that is, the peers change their social relations during a time period, such as company employees where an employee may be promoted and the social relations with respect to other employees are altered.

In exemplary embodiments of the invention, peers comprise sub-groups of peers, where a sub-group is characterized by particular relations with respect to the peers of the sub-group and/or other peers and/or another sub-group. Optionally, a sub-group may, at least partially, overlap with another sub-group. For example, in a group comprising members of a school, the teachers may comprise a sub-group with particular social relations between the teachers (e.g. symmetric), and with particular relation with respect to a sub-group of the students (e.g. asymmetric).

In exemplary embodiments of the invention, the social relations may be more intricate and may comprise a combination of symmetric, asymmetric, static, dynamic or transient (ad-hoc) nature.

In exemplary embodiments of the invention, social relation are based, at least partially, on a self-interest or self-interests of a peer. Optionally, according to the self-interests a peer determines to cooperate with other peers and to provide them with information or data. Optionally, the self-interests of a peer effect cooperation for a short term or long term gain or optional gain. Optionally, the gain is in terms of data or revenues obtained from other peer or opportunities for future gains. Optionally, the gain is determined against penalties such as consumption of resources or costs of communications.

### Factors Affecting Cooperation

In exemplary embodiments of the invention, a peer cooperation with one or more peers is determined, to varying extents, according to one or more of the following factors or their combination:

(a) The benefits an applicant received, or committed to receive, from one or more donors. For example, the count and volume of data an applicant received from a donor.

(b) The demand on a donor from one or more applicants. For example, the count, rate and type of requests from a particular applicant or one or more of applicants, the number of responses and the count and volume of data sent out by the donor to one or more applicants.

(c) The resources available to a donor. For example, the battery capacity of a phone or signal power level of a phone or available bandwidth.

(d) The costs and/or revenues of receiving and/or sending data. For example, the costs of sending a data object, the costs of querying about or requesting a data item, or cost of connection when receiving data, or revenues obtained for providing the data, or a refund due to amount of using a service such as a cellular provider.

(e) The merits of the data to a peer (see later). For example, a data item may be important to an applicant and may further induce the applicant to cooperate with a donor that has that item, relative to receiving a less important data item.

(f) Timing. For example, a peer may increase cooperation with a donor that provided information or data recently rather than long time ago, or a donor may cooperate in sending data in a low cost time such as, optionally, weekend.

(g) Hierarchy. For example, cooperation of a junior with a senior may be higher than otherwise (e.g. due to self interest to avoid penalties or for optional gain in the future).

(h) The distribution of a data object among the peers. For example, when there is a demand for a rare data item a donor having the data may be bombarded with requests, causing the donor to diminish the interest to cooperate. Another example is when a data item is stored with several donors then if only one or few donors are requested for that data the donor or donors may lower the interest to cooperate.

One or more of the following factors (a)-(h) listed above, or their combination, will be referred to as ‘cooperation factors’.

### Fairness

In exemplary embodiments of the invention, the interaction for data sharing between peers is adapted such that a peer would cooperate and participate in data sharing rather than retain the data for itself and/or preserve its resources and/or avoid extra costs. The adaptation of the interaction may be characterized by the concept of ‘fairness’. The term does not necessarily mean absolute or approximate justice. Rather, it means a certain measure (or measures) according to which a peer determines if to provide information or data to another peer. Optionally, an acceptable fairness degree or range of degrees may be agreed upon, and/or expected, and/or estimated, and/or implied, and/or perceived, and/or determined.

In exemplary embodiments of the invention, a fairness degree is determined, to varying extents, according to the cooperation factors.

In exemplary embodiments of the invention, a fairness degree is determined, at least partially, with respect to peers hierarchy. Optionally an applicant peer may be denied of data from a certain donor peer, but according to the fairness degree the applicant still considers it as fair. For example, a worker may determine as a fair conduct when a manager declines to provide data to the worker, and the worker may still determine as fair to provide data to the manager. Similarly, a child phone may provide data to a parent even if the battery is almost exhausted, while a parent phone does not yield data to a child even if the battery is fully loaded, as the child understands, or perceives, that such relations are ‘fair’.

In exemplary embodiments of the invention, the fairness degree of a peer is determined responsive to cooperation of the group as a whole, or a sub-group or certain peers. For example, a donor may determine as fair to provide data to an applicant that did not provide any data to the donor, provided that the donor did receive data from other members of the group. As a contrary example, a student may not share lecture notes if it was overloaded with requests from other students and/or did not get notes from others.

In exemplary embodiments of the invention, the fairness degree of one peer towards one or more peers degree is modified during the operation of data sharing. Optionally the fairness degree is modified responsive to the varying states or levels of the cooperation factors. Optionally or alternatively, the fairness degree of a donor peer towards an applicant peer change as a reward or penalty responsive to the applicant interaction, or optionally responsive to the interaction of other peers. For example, if a donor provides data to an applicant, the applicant would, as a reward, increase the fairness degree towards the donor (e.g. cooperation factor (a)); or, for example, if an applicant queries a donor many times or in high rate (e.g. consuming resources of the donor), the donor may, as a penalty, reduce the fairness degree towards the applicant (e.g. cooperation factor (b)).

In exemplary embodiments of the invention, the fairness degree of a peer towards one or more peers is responsive to a particular data it owns or want.

In exemplary embodiments of the invention, a peer notifies one or more peers of the fairness degree towards one or more peers.

In exemplary embodiments of the invention, the fairness degree is expressed as a value which reflects relative a fairness with respect to other peer or peers. For example a value between 0 and 100, representing lowest and highest fairness, respectively, wherein a value of 50 or above indicates that it is fair to cooperate. Optionally, other values and/or ranges may be used such as positive and negative values, wherein positive values indicate that it is fair to cooperate.

### Willingness

In exemplary embodiments of the invention, the interaction for data sharing between peers is responsive to a willingness degree of a peer towards one or more peers. Optionally, the willingness degree reflects a level of consent and/or or interest of a donor peer to provide data or information to an applicant peer.

In exemplary embodiments of the invention, a willingness degree is determined, to varying extents, according to the cooperation factors (similarly to the fairness degree but optionally with different extents of the cooperation factors). Optionally, the willingness degree is related, or responsive, to the degree of fairness, at least partially.

In exemplary embodiments of the invention, a willingness degree is determined, possibly beyond the cooperation factors, according to additional factors. For example, a peer may allocate resources, or bear excessive costs, or offer information, or send data, beyond what is determined or expected according to the fairness degree towards other peers. Optionally, a donor peer contributes resources or data to one or more peers for short or long term gains. For example, for initiating or maintaining interaction between peers, consequently increasing the opportunities of the donor to obtain data from other peers, and optionally increasing the fairness and/or willingness degree of other peers towards the donor so that they will determine that it is appropriate to provide data to the door. Optionally, a peer decreases the willingness degree towards one or more peers, deprive information or data or resources from the other peers, even if the fairness degree is appropriate for cooperation. For example, when the peer interests are to preserve resources or avoid extra costs.

In exemplary embodiments of the invention, the willingness degree of a peer towards one or more peers is responsive to a particular data it owns or interested in. Optionally, a donor may increase its willingness to contribute (e.g. beyond the fairness determination) small or popular data or some particular data that the donor owns.

In exemplary embodiments of the invention, a peer notifies one or more peers of the degree of willingness of the peer towards one or more peers. Optionally, the notification is a part of negotiating with or querying the peer by one or more peers. Optionally, a peer broadcasts the willingness degree towards one or more peers. Optionally, the broadcast is to particular peers, such as those to which the willingness degree pertains.

In exemplary embodiments of the invention, the willingness degree of one peer towards one or more peers is modified during the operation of data sharing. Optionally the willingness degree is modified responsive to the varying states or levels of the cooperation factors. Optionally or alternatively, the willingness degree of a donor peer towards an applicant peer change as a reward or penalty responsive to the applicant interaction, or optionally responsive to other peers interaction. For example, if a donor offers data (e.g. as a donation, according to the donor interests) to a peer, that peer would, as a reward, increase the willingness degree (and optionally the fairness degree) towards the donor, possibly with larger increment than responsive to a query; or, for example, if a donor does not send data or information to an applicant that is aware of the free resources of the donor, the applicant may, as a penalty, reduce the willingness degree towards the donor, possibly with a decrement larger relative to a fairness degree decrement.

In exemplary embodiments of the invention, a peer modifies the willingness degree towards one or more peers arbitrarily or upon some statistical estimates, and notifies other peers of the new willingness degree. The modified willingness degree may increase future cooperation between peers, consequently increasing the opportunities of the peer to obtain data. Optionally, a peer modifies the willingness degree towards one or more peers periodically (e.g. every hour) and/or when a peer determines that data sharing interaction subsided relative to other times, consequently stimulating the interaction and cooperation.

For example, a peer increases the willingness degree towards one or more peers leading applicants to apply to the peer, reducing demand on other peers that might eventually reduce their willingness degree and decline to cooperate, at least for some time. Another example is lowering the willingness degrees towards one or more peers leading applicants to apply for data from other peers (with higher willingness degrees relative to the reduced degree), consequently distributing the interaction between other peers more evenly. Another example is arbitrarily lowering and increasing the willingness degree towards one or more peers, consequently disrupting a stagnant interaction and reviving the cooperation and yielding more opportunities to obtain data.

In exemplary embodiments of the invention, the willingness degree of a peer towards one or more peers is set by the owner of the phone. Optionally, a preset willingness degree is initially set for the whole group a sub-group or a plurality of peers. Optionally, a donor notifies an applicant of the willingness degree of the donor towards the applicant. Optionally, an applicant estimates the willingness degree of a donor towards the applicant. Optionally, the applicant estimation is based on past willingness degrees of the donor known to the applicant or to other peers. Optionally or alternatively, a donor willingness degree towards an applicant is estimated based on the willingness degree of the donor towards other peers, optionally of peers belonging to the same sub-group.

In exemplary embodiments of the invention, the willingness degree and the fairness degree of a peer towards one or more peers are the same, or approximately the same. Optionally, the willingness degree deviates from the fairness degree. Optionally, the willingness degree is higher and/or lower from the fairness degree, optionally reflecting momentary self interest (e.g. saving energy), short term interest (e.g. providing data to an applicant expecting to receive in return an interesting data), or long term (e.g. breaking a slow interaction pattern within a group for optional future opportunities).

In exemplary embodiments of the invention, the willingness degree is expressed as a value which reflects relative willingness with respect to other peer or peers. For example a value between 0 and 100, representing lowest and highest willingness, respectively, wherein a value of 50 or above indicates that a peer is willing to cooperate. Optionally, other values and/or ranges may be used such as positive and negative values, wherein positive values indicate that a peer is willing to cooperate.

In exemplary embodiments of the invention, the interaction for data sharing between peers is responsive to one of a fairness degree or a willingness degree or a combination thereof.

### Social Model of a Peer and Social Account Bookkeeping

In exemplary embodiments of the invention, the social relations and interactions for data sharing of a peer on behalf of the peer owner with respect to one or more peers owners is modeled, at least partially, by a set of rules, actions and values and/or states (parameters)—hereinafter a peer social model or a peer model or a model. Optionally, the model is employed or comprised on a peer representing the owner. Optionally, the model is implemented as an agent (see later) of a peer.

In exemplary embodiments of the invention, a peer model comprises one or more parameters representing and/or reflecting some of the characteristics of the social relations and interactions between the peer and one or more peers, such as hierarchy or fairness degree or willingness degree.

In exemplary embodiments of the invention, the model comprises operations between peers models, the operations optionally relating to or comprising sharing of data between the peers.

In exemplary embodiments of the invention, the data sharing interaction between models is responsive to actions determined by the model rules and/or the model parameters.

In exemplary embodiments of the invention, the model is modified responsive to data sharing. Optionally, at least one of the rules and/or the parameters and/or the actions is modified.

In exemplary embodiments of the invention, the model comprises one of the following activities (actions), or a combination thereof:
(a) Maintaining social relations of a peer with respect to one or more peers such as hierarchy;
(b) determination of a fairness degree, the fairness degree optionally responsive to the social relations and interactions with one or more phone models;
(c) determination of a willingness degree for interaction and/or data sharing between a peer and one or more peers;
(d) interaction and data sharing between the model of one peer and one or more peers, optionally aiming to achieve and/or maintain an acceptable fairness degree and/or willingness degree for cooperation between a plurality of peers.
(e) maintaining and bookkeeping social accounts (see below) respective to other peers models; optionally the accounts and bookkeeping employed in determination of a fairness and/or willingness degree; and
(f) communicating and sharing data responsive to information maintained in the social accounts of the peers models; optionally sharing data is responsive to a search for data by one or more peers (see later).

In exemplary embodiments of the invention, the peer social model comprises parameters expressing states and values that represent, at least partially, the social relations of a peer with respect to one or more peers. Optionally, the parameters relate to the activities and features (a)-(f) listed above, such as a willingness degree of a peer for providing data to one or more peers, or a value representing a relative hierarchy of a peer relative to one or more peers.

In exemplary embodiments of the invention, a social model of a peer maintains a degree of relative hierarchy, e.g. between 0 and 100, wherein 0 represents some arbitrary baseline hierarchy degree of a group or a sub-group or a plurality of peers. For example, a model of senior, e.g. a parent, may have a hierarchy parameter value (degree) such as 70, while a junior, e.g. a child, is assigned (optionally by a senior) a degree of 10, so that the junior is lower in hierarchy relative to the senior. Therefore, when the junior is queried for data from a senior, the junior takes into account the relative hierarchy in order to determine a fairness degree and/or willingness degree to respond and provide data to the senior. That is, the junior increases the value of a fairness and/or willingness parameter relative to other juniors of the same or about the same hierarchy. Using the exemplary values above, and assuming a fairness degree of 30 of the junior towards a senior, the junior may update the fairness degree towards the parent by a formula such as:

FDN=FD+(HA−HD)×K, where HD and HA are the hierarchies degrees of the applicant and donor, respectively, K is a proportionality constant (e.g. 1) and FDN is the new fairness degree of the applicant taking into account the relative hierarchies. Accordingly, the fairness degree of the junior towards the senior will be 30+(70−40)=60.

Optionally, other formulas or methods may be used to determine the fairness (and likewise, the willingness) with respect to hierarchy. Optionally, the new fairness (or willingness) degree is stored for later use, or recalculated upon each query.

In exemplary embodiments of the invention, hierarchy may be set at a plurality of preset levels, for example, very high, high, medium, low, very low.

In exemplary embodiments of the invention, the hierarchy may be set between one model and one or more models, optionally irrespective of the hierarchy range or scale of other models.

In exemplary embodiments of the invention, a peer model sets one or more parameters and/or rules and/or actions of one or more other models. For example, a model of a conference coordinator may set parameters of participants models, possibly with different parameters or values respective to lecturers and ordinary participants.

In exemplary embodiments of the invention, a model obtains one or more parameters and/or rules and/or actions from one or more other models, so that it may optionally copy, or model, the model of the another peer. Optionally or alternatively, a model may send parameters to be used by one or more other models.

In exemplary embodiments of the invention, according to the exchange of parameters and/or rules and/or actions as described above, a peer models the social model of another peer.

### Social Account

In exemplary embodiments of the invention, at least some of the parameters of a peer model are characterized as pertaining to social relations and/or interactions of the peer relative to another peer (mutual relations). For example, a fairness degree with respect to the other peer, a willingness degree with respect to the other peer, amount of data received from the other peer or peers, willingness degree of the other peer or peers with respect to the peer or such other mutual parameters. The mutual parameters, optionally together with parameters pertaining to the peer itself, such as hierarchy of the peer, are considered as the social account of the peer with respect to the other peer or peers (or ‘social account’ for short). Optionally, in this manner the social account is dedicated to and represents, at least partially, the social relations and interaction of the peer (and indirectly the peer owner) with respect to one or more other peers.

In exemplary embodiments of the invention, social account is a virtual one, that is, the social account is defined by the characteristics of the parameters and/or relations to other peers. Optionally the social account, at least partially, is arranged or comprised in a structure, such as a table.

In exemplary embodiments of the invention, the owner of the peer sets one or more parameters of the social account. manufacturer. Optionally, the owner sets one or more parameters pertaining to a plurality of peers such as the group, a sub-groups or some particular peers or common to all peers. For example, initial willingness degree (towards one or more peers, or a common degree), hierarchy, percentage or amount of resources to reserve or allocate for interaction (e.g. battery life, bandwidth), or costs allocation for data queries and transmission. Optionally, the parameters are set when joining the network, or when a group or sub-group is formed (see later) or on any other event or occasion, Optionally, the model and/or one or more of the model parameters are set by entities such as a cellular provider or phone

In exemplary embodiments of the invention, a model sets one or more of its own parameters. Optionally, the parameters are default values. Optionally or alternatively, at least some of the parameters are responsive to past operation of the model and/or other one or more models. For example, fairness and/or willingness degree of an applicant with respect to a donor is increased when the donor sends data to the applicant. As another example, a donor model may recognize an applicant model as a senior (e.g. a parent such as by the caller ID) and set or adapt the donor hierarchy with respect to the applicant and/or with respect to other peers.

In exemplary embodiments of the invention, the parameters are set responsive to factors such as location, proximity to other peers, signal level, costs of communications, energy, bandwidth, available memory, processing power and other factor such as time. Optionally, a parameter is modified during the operation of the model.

In exemplary embodiments of the invention, as peers join the or start operation, their models assign to one or more parameters a baseline level or statistical value or random value (optionally within a practical range and/or within preset limits). Optionally or alternatively, one or more parameters are modified responsive to information exchanged between the models and/or to traffic between them.

In exemplary embodiments of the invention, an applicant model consults the social account respective to one or more peers to determine which peer to query for information or data. Optionally, the determination is responsive to the hierarchy and/or fairness and/or willingness degree of an applicant with respect to a donor and/or the donor with respect to the applicant, and/or the willingness and/or fairness degree of the applicant to query the donor. Optionally, according to the determination, an applicant peer requests information or data from a donor and updates the social account respective to the donor. Optionally, the applicant notifies the donor about the applicant hierarchy or the applicant willingness or fairness degree towards the donor. Optionally, according to the response from the donor the social account of the applicant with respect to the donor is updated. For example, the fairness degree or willingness degree with respect to the donor, or the donor willingness degree with respect to the applicant or a count of data items received, or a count of the volume of data received, or a count of the number of queries sent to the donor. Optionally, when a donor receives a query from an applicant, or send information to or data to the applicant, the donor updates the social account respective to the applicant. For example, the count of queries form the applicant, a count of data sent, or the volume of data sent. Optionally, donor informs an applicant of the data it has, or the willingness degree of the donor with respect to the applicant, or the hierarchy of the donor, so the applicant may update the social account respective to the donor. The maintenance and updating of a social account is referred to as ‘bookkeeping’ of the social account.

In exemplary embodiments of the invention, the fairness degree and/or willingness degree in a social account of a peer with respect to other peer is maintained and updated as described before, such as according to the cooperation factors and items (a)-(f) above. Optionally, a model notifies one or more models of information in the model social account (optionally with respect to the group, a sub-group or a plurality of peers) so that they can tune their interaction with respect to the notifying peer. Optionally, the notification is according to variation of a willingness degree as described before.

### Peer Agent

In exemplary embodiments of the invention, a peer model (e.g. of phone 102) is implemented (coded), at least partially, as a program on a peer phone, the program referred to as an ‘agent’. Accordingly, the agent represents, at least partially, the social relations of the peer owner and operates on his or her behalf for cooperation and data sharing.

In exemplary embodiments of the invention, the agent comprises a software comprising one or more modules that use the memory and/or CPU and/or hardware and/or software of the phone. Optionally or alternatively, an add-on unit or units are used, comprising software and/or hardware, optionally with an extra CPU. Optionally, the software comprises existing and/or add-on firmware. Optionally, the agent comprises other resources such as a server or facilities of the cellular network provider, or a server of the phone provider or manufacturer, or other devices or other peers.

In exemplary embodiments of the invention, the agent comprises data beyond the model for management and/or control, such data buffering, sequencing of messages, tracking battery capacity, calculating communication time and/or costs and/or accessing phone 102 functions.

In exemplary embodiments of the invention, the agent comprises code and/or parameters to manage the group members. For example, contact identification of members peer such as phone numbers 208 or obtaining a contact respective to other identification, such as obtaining a phone number 208 respective to a owner name.

In exemplary embodiments of the invention, the agent may access facilities of phone 102, such as a contacts directory 202 or a battery voltage. Optionally, the agent may control and/or manage functions such as initiating and receiving calls or sending and/or receiving messages and/or data. Optionally, the access is coordinated with other activities of phone 102 such as voice communications. Optionally or alternatively, the agent access is, at least partially, independent of other activities of the phone, such as using different protocol and/or different band and/or different bus and/or different CPU (or CPU core).

In exemplary embodiments of the invention, the agent calculates and/or estimates costs of using phone 102. Optionally or alternatively, the agent calculates and/or estimates costs of data sharing activities such as query about, sending or receiving data. Optionally, costs are determined according to data size, available resources, payment program and/or geographical locations. Optionally, the agent may calculate and/or estimate revenues.

In exemplary embodiments of the invention, the agent may control and/or limit the usage of resource for interaction and sharing. For example, limit the CPU time allocation for data interaction.

In exemplary embodiments of the invention, phone 102 obtains at least a part of the agent program and/or parameters from a server, for example, a server maintained by a cellular provider, a telephone manufacturer and/or a third party. Optionally, phone 102 obtains at least a part of the agent program and/or parameters from one or more phones 102.

In exemplary embodiments of the invention, the agent provides a user interface (UI). Optionally, the UI display entry fields to enter information about the peer, optionally pertaining to cooperation for data sharing. For example, to enter an ID of the peer (e.g. phone number, name or code), classification (e.g. family name, school and/or class, business name and/or title), hierarchy, fairness and/or willingness degree or other parameters pertaining to cooperation for data sharing. Optionally, the UI displays fields to enter ID and/or social account parameters for other peers known to the peer and that the owner chooses to include in a group for data sharing. Optionally, the UI comprises entering field codes and parameters in addition and/or instead of presented fields. Optionally, the agent sets defaults values to social account parameters, optionally in addition to values set by the owner. Optionally, the agent sets value responsive to parameters set by the owner (or by a service or a third party). For example, setting a hierarchy according to classification, e.g. if the owner is a parent (such as the one who opened a service account), or a manger, or other senior, the agent sets a high hierarchy relative to juniors hierarchy. Optionally, the agent comprises preset hierarchy levels (e.g. low medium high) according to which hierarchy degree (or fairness or willingness degree) is set.

In exemplary embodiments of the invention, the owner of a peer enters, or loads, information (e.g. keywords, see later) related to interesting data, such as keywords relating to an event, or that the owner interested in, or that friends are interested in, or other interesting data. Optionally, the keywords are used in searching for data characterized by the keywords (see later).

### Group Forming and Size

In exemplary embodiments of the invention, peers comprise a group characterized by identifications (ID) unique to each peer, wherein, optionally, the identifications are accessible by the phones

In exemplary embodiments of the invention, a group of peers is formed as applicant peers query donor peer about data items or related information, for the first time (or after a certain time of no interaction). As a query is made, a donor peer optionally acknowledges the query and optionally registers the applicant peer as part of the donor group (or just a newly formed group) for future cooperation. Optionally, the applicant registers the donor similarly. Optionally, the donor rejects the applicant, for example, by not responding and/or not registering it. Optionally, the donor may respond, such as on an ad hoc manner, but without registering the applicant for future interaction and/or for inclusion in a group.

In exemplary embodiments of the invention, peers are identified by an ID such as phone number, peer name, owner name or part of the owner name, or owner nickname or code or other unique identification. Optionally, in a cellular connection the SIM number may be used. Optionally, when the connection is TCP/IP, the ID is the IP number of a peer and/or optionally other ID such as MAC number or the peer device.

In exemplary embodiments of the invention, the registration is performed by a peer agent. Optionally, registration comprises setting a peer ID in the memory of a peer. Optionally, the registration comprises setting a social account respective to the other peer, optionally setting default values to parameters such as hierarchy, and/or fairness degree and/or willingness degree and/or other parameters of the account such as management parameters.

In exemplary embodiments of the invention, when an applicant queries a donor for joining a group, and optionally when a donor responds, the peers agents provide each other with information such as classification (e.g. family name, school and/or class, business name and/or title), hierarchy, fairness and/or willingness degree or other parameters pertaining to cooperation for data sharing. Optionally, the agents exchange information about known members, registering them in respective new social accounts, optionally updating parameters of members that are already registered. Optionally, a peer agent provides information about the peer device such as battery reserve or cost program (e.g. evening or weekend rates).

In exemplary embodiments of the invention, an applicant peer queries a donor peer about a particular data, and optionally the donor recognizes the data (e.g. by keywords, see later) as one of relating to an event the peer participated in, or other occasions (e.g. previously requested data), or that the peer recognizes the data as interesting (see above). Optionally, according to the keyword the donor registers the applicant (and optionally the applicant registers the donor) as described above.

In exemplary embodiments of the invention, a peer may broadcast (e.g. contact a plurality of peers), providing the peers with the broadcaster ID (and/or other information). Optionally, the agents of the broadcaster peer and the contacted peers may register each other as described above, optionally registering other members as described above.

In exemplary embodiments of the invention, a donor peer recognizes the applicant (or broadcaster) ID (e.g. phone number) and sets or updates the donor social account with respect to the applicant. For example, a child may recognize a parent ID and consequently lower the donor hierarchy (at least towards the parent, optionally according to preset levels in the agent), or a parent may recognize a child and register the applicant (e.g. in the respective social account) with some privilege over other peers.

In exemplary embodiments of the invention, a group comprises, at least partially, predefined or preloaded numbers (or other ID), such as numbers of family members or class mates. For example, a peer owner may enter the phone number of members (or potential members). Optionally or alternatively, the numbers are loaded via a computer or server, optionally via a transmission. Optionally or alternatively, the numbers are loaded by a device such as USB storage device. Optionally, the service provider provides or loads the ID, e.g. according to registered persons charged with the same credit card). Optionally, the members ID are loaded from other service, such as that of the phones manufacturer.

Optionally, the phone numbers of members of a group are stored in a peer phone directory, or optionally or alternatively, the numbers are stored in the social accounts of the m ember or respective to the members. For example, an applicant peer may store the applicant ID (e.g. phone number) in the applicant social account and the donor ID in the social account of the applicant with respect to the donor

In exemplary embodiments of the invention, the phone numbers (or other ID) stored in the phone directory (or parameters of the agent) represent the at least a part of the group members. In such a manner, optionally, the group comprises the shared numbers of the members phones (i.e. an intersection of directories numbers).

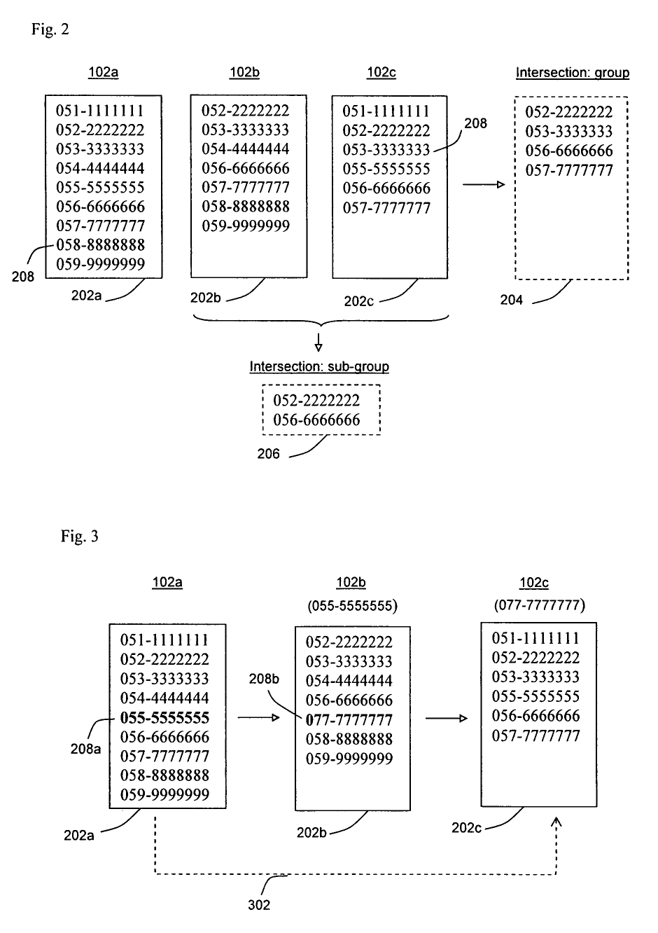

FIG. 2 schematically illustrates a group of peers comprising an intersection 204 and 206 of phone numbers 208 in phones directories 202, in accordance with an exemplary embodiment of the invention.

In exemplary embodiments of the invention, cellular phones 102 store a directory 202 of phone numbers 208. Typically, directory 202 comprises phone numbers 208 of persons with some social relations with other peers, for example, family, friends, colleagues, business partners, etc. As such, optionally, phone numbers 208 define, at least partially, the group that take part in data sharing.

In exemplary embodiments of the invention, a group is defined as an intersection 204 of phone numbers 208 in directories 202. For example, intersection 204 comprises the intersection of directories 202a, 202b and 202c of respective phones 102a, 102b and 102c. Optionally or alternatively, the peers and respective phones 102 may belong to a sub-group 206 which, at least partially, may overlap. For example, intersection 206 defines a sub-group comprising numbers 208 from 202b and 202c, which partially overlap numbers 208 of 204.

In exemplary embodiments of the invention, a group may be formed, at least partially, by contacting a service (e.g. cellular provider or a server of service of the manufacturer of the peer device) and registering itself in the service, optionally providing details such as a group name, peer name, peer phone number 208 (or other ID such as IP or MAC number) and/or relations to other peers registered non registered (e.g. family name, school name and/or class). Optionally, the peer may provide details relating to known friends, or colleagues or others that the contacting peer determined to include in the group, for example, stating the additional peers relations to the peer (e.g. family relations, class mate, business name and/or title). Optionally, the peer registers other peers (e.g. family members or employees) in the service.

Subsequently, an applicant peer may contact the service (or server) and request the service (or server) to establish a contact with a peer (e.g. by stating the peer ID such as name). Optionally or alternatively, an applicant may request the service to provide the applicant with a donor phone number so the latter may query a donor. Optionally, the service may privilege peers that use the service frequently and/or heavily, whereby the service obtains more revenues from those peers relative to others, (e.g. faster contact to other peers, faster transfer, or lower costs).

In exemplary embodiments of the invention, a peer in the group can contact another peer in the group by using the ID, for example, phone number or IP. Optionally, the ID is used to identify the contact method, for example, using a name to find the respective phone number 208. Optionally, a phone 102 (or server or service) serves as a relay to other phones, for example, providing a contact number of another phone.

FIG. 3 schematically illustrates a contact of one peer 102a to another peer 102c via a relay (intermediate) peer 102b, in accordance with an exemplary embodiment of the invention.

Directory 202a of peer 102a comprises the phone number 108a of peer phone 102b. Phone 102b comprises in directory 202b the phone number 108b of peer phone 102c. Peer 102a calls peer 102b and requests the phone number 108b of peer 102c, subsequently calling the destination 102c, so that a contact is achieved between 102a and 102c, as depicted in contact arrow 302.

In exemplary embodiments of the invention, the cellular provider relays contacts between peers. Optionally, the cellular provider, and/or a server, comprises phone numbers 208 so that peers may access them and use them to contact peers 102 as described above, or optionally or alternatively, request the service provider to perform the contact.

In exemplary embodiments of the invention, the service provider, or other service or server stores the contact ID such that phone numbers 208 are, optionally, characterized to define the group or a part of the group. Optionally, other ID for contacts are stored, e.g. IP or MAC number, or names or a code name.

In exemplary embodiments of the invention, the peers group is limited in size. Optionally, the group size is limited by the number of peers with some aspect of social relations (e.g. family). Optionally, the size is limited by the phone directory capacity of one or a plurality of phones. Optionally or alternatively, the group size is limited by the smallest capacity of a directory of all, or part of, the peers that are candidate for or take part in the data sharing. Optionally, the group is limited by other factors such as the space a service allocates for storing contacts (which may be larger for due payment) or geographic distance such that distant peers (and optionally costly to commutate with) are not included in the group, for example, a family member traveling overseas.

In exemplary embodiments of the invention, the group size varies during the operation of the peers. For example, peers that do not participate, or participate substantially less than others, may be rejected from the group. Optionally, peers that provide data or provide substantially less than other peers may be rejected from the group. Optionally, the rejection comprises ignoring requests from rejected peers, so that they may establish their relations once they begin to cooperate (i.e. temporal rejection). Optionally or alternatively, the rejection comprises removing the rejected peers from the group so that they will have to register again and start to cooperate (i.e. provisional rejection). Optionally or alternatively, the rejection comprises denial to register or to respond to the rejected peers (e.g. permanent rejection), at least for a certain time period (e.g. a week)

In exemplary embodiments of the invention, the group size comprises between 5 and 100 peers. Optionally, the size is of the order of or a few hundreds. Optionally, the group size is approximately 1000. Optionally, the group size is between 1000 and 10,000. Optionally, the group size is larger than 10,000. Optionally, the group size, particularly of large groups, is responsive to increased capacity of the phones, for example, by adding add-on memory cards or devices or by upgrading the phones or by using new technology.

In exemplary embodiments of the invention, the group comprises a full graph topology, that is, each peer can contact all other peers directly (or via a relay such as another peer or a service), as shown in common connections 108 of FIG. 1.

In exemplary embodiments of the invention, the group comprises one or more servers or computers working on behalf of peers or other entities. For example, a service of a cellular provider (or a service of the peer manufacturer) may intercept or take part in data sharing in order to charge or refund a peer account responsive to data sharing or amount of usage. Optionally, the cellular provider, or a server of another organization, may provide and share data, for example, organization such as YouTube (trademark youtube.com) or Flickr (trademark yahoo inc.).

In exemplary embodiments of the invention, a group may be divided to sub-groups. Optionally, a sub-group may comprise members with certain classification, for example, family members in a social event that comprise non-family members. Optionally or alternatively, sub-groups may comprise of peers with interest in a particular kind of data (e.g. movies, see below). Optionally, sub-groups may, overlap, at least partially. Optionally, the agent or agents define the sub-groups according to the classification or data of interest (e.g. cartoons movies). Optionally or alternatively, the peer owner defines a sub-group. Optionally, the agent defines a sub-group responsive to parameters entered by the peer owner. Optionally, peers give privilege, or higher hierarchy, to member peers in the same sub-group as the peer.

### Type and Size of Data Object

In exemplary embodiments of the invention, the data object type is not limited and may comprise, for example, text, images, video, music or any combinations of such types. Optionally, the data comprises large volumes such as images, video and musical pieces relative to short data such as text messages, clips arts, or ring tones.

In exemplary embodiments of the invention, the data is identified by one or more keywords, optionally within the data. Optionally, the data is tagged by an industry standard for tagging, for example, EXIF or IPTC. Optionally or alternatively, other standard or non-standard tagging may be used such as or movies with a review or tagged data such as name, actors, director and such. Optionally or alternatively, other attributes of a data may be used to identify the data such as the data origin, date or size.

In exemplary embodiments of the invention, the data is large relative to the resources of the phone such as memory, processing power or bandwidth. Optionally, the data transfer is costlier than regular uses of the phones such as voice communications. Optionally, data sharing may consume more than 20% or more than 50% or more than 70% of the bandwidth and/or processing power of the phone relative to voice communications for about the same period. Optionally, the memory utilization in data sharing may consume more than 20% or more than 50% or more than 70% of the relative to voice communications for about the same period. Optionally, the cost of data sharing may be more than 20% or more than 50% or more than 70% relative to voice communications for about the same period.

In exemplary embodiments of the invention, the size of data is less than IKB. Optionally, the size is in the order of a few KB up to 10 KB. Optionally, the size is between 10 KB to 100 KB. Optionally, the data size is of the order of IMB. Optionally, the size is a few MB. Optionally, the data size is between 10 MB to 100 MB. Optionally, the data size is larger than 100 MB. Optionally, the data size may be responsive to increased capacity or bandwidth of the phones, for example, by adding add-on memory cards or devices or by upgrading the phones or network such as by new technology.

In exemplary embodiments of the invention, peers may obtain data in various manners. For example, downloading from the internet (e.g. by protocols such as GPRS), receiving from other peer such as by SMS or MMS, or connecting to other sources by LAN or Bluetooth or via USB or other connections. Optionally, a peer may acquire the data directly such as by taking pictures or recording sound or video. Optionally, peers do not store some data but, rather, have direct access to it on another device, for example, documents are stored in a computer and a cellular phone access them via connections such as Bluetooth, USB or Internet. Optionally, the data obtained as described above is shared, or is candidate for sharing, with other peers.

In the following discussions, unless otherwise specified, the term ‘object’ and/or ‘data’ denotes a data object.

### Data Merits (Rating)

In exemplary embodiments of the invention, the merits, or rating, of data may affect, along with other attributes, the fairness or willingness degree as described above.

The merits of data optionally relate to characteristics of the data and/or its related information, for example, the content of the data and/or some auxiliary information such as terms that appear in the data tagging (e.g. actor name).

For example, one or more or the listed characteristics below may relate to the merits or rating of the data, at least for one or more peers.

(a) the significance or importance of the data (as perceived by the applicant and/or donor);

(b) the frequency (or abundance) of the data among the peers or other media such as magazines, television or internet;

(c) the popularity of the data (which may not be frequent among the peer yet)

(d) the frequency or count of sharing the data;

(e) volume of the data;

(f) the age or data of the data;

(g) the rating of the data such as by appropriate age (e.g. kids, youth, adults);

(h) or contents (e.g. family, books, politics); or

(i) type of data (e.g. movies, text, pictures, audio).

The merits or rating may optionally comprise a weighted combination of the listed characteristics above and/or others optional characteristics that contribute to a preference of a data item over another one.

### Object Search

In exemplary embodiments of the invention, data sharing between peers comprises a request by an applicant for object from one or more donors. Optionally, the search begins when an applicant queries a donor to verify if it has a particular object. Optionally, the applicant provides in the query one or more keywords relating to and/or identifying the object (as described above). The process of querying and/or requesting for an object comprises a search for the data.

In exemplary embodiments of the invention, a donor stores the object in the donor memory and/or agent. Optionally or alternatively, the object is stored on other peers or other locations (e.g. a server) and the donor notifies the applicant where it is stored (e.g. a link to a web page or a UNC path to a server). Optionally, the object is stored on other mediums, for example, a server of a service provider and the donor can access and retrieve them. Optionally or alternatively, the donor notifies the applicant about a similar object (as the donor determines the similarity, e.g. a text by the same author or by synonyms of keywords).

Hereinafter, unless otherwise specified, referring to a donor having an object implies one of the above mentioned variations of access to the data.

In exemplary embodiments of the invention, when a donor receives a search keyword and does not find a match it tries to find similar words, or synonym of the words (e.g. ‘depart’ for ‘leave’), or roots of the words (stemming, e.g. ‘move’ for ‘moving’), or inflection of the words (e.g. ‘moving’ for ‘move’ or ‘go’ for ‘went’). Optionally, the substitution is performed by the peer agent or optionally or alternatively, by a service or by using a server. Optionally, wild card or regular expression mechanisms may be used to identify the object. Optionally or alternatively, logical combinations such as AND/OR/NOT may be used.

In exemplary embodiments of the invention, the applicant owner sets the search keywords and/or combinations and/or variations, optionally via the agent UI. Optionally, the search keywords and/or combinations and/or variations are retrieved from a past search stored by the donor or applicant or other peers or a server or a service (see below).

In exemplary embodiments of the invention, physical or other attributes may characterize the object. For example, object stored within a certain proximity (which could be notified by peers or informed by the cellular provider), or date or size ranges of the object, or object of certain sub-group (e.g. class mates), or other attributes such as costs of sending and/or receiving the object. Optionally or alternatively, a combination of textual and other attributes may be used to identify or search the object, for example, a combination of the keyword ‘president’ and limiting the search to items from the last two days.

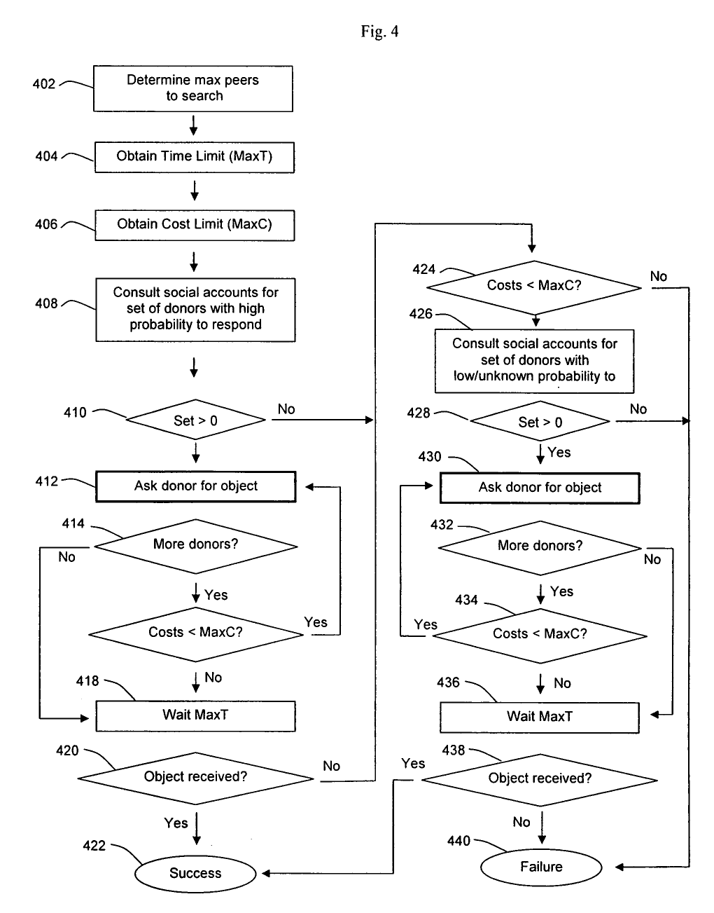

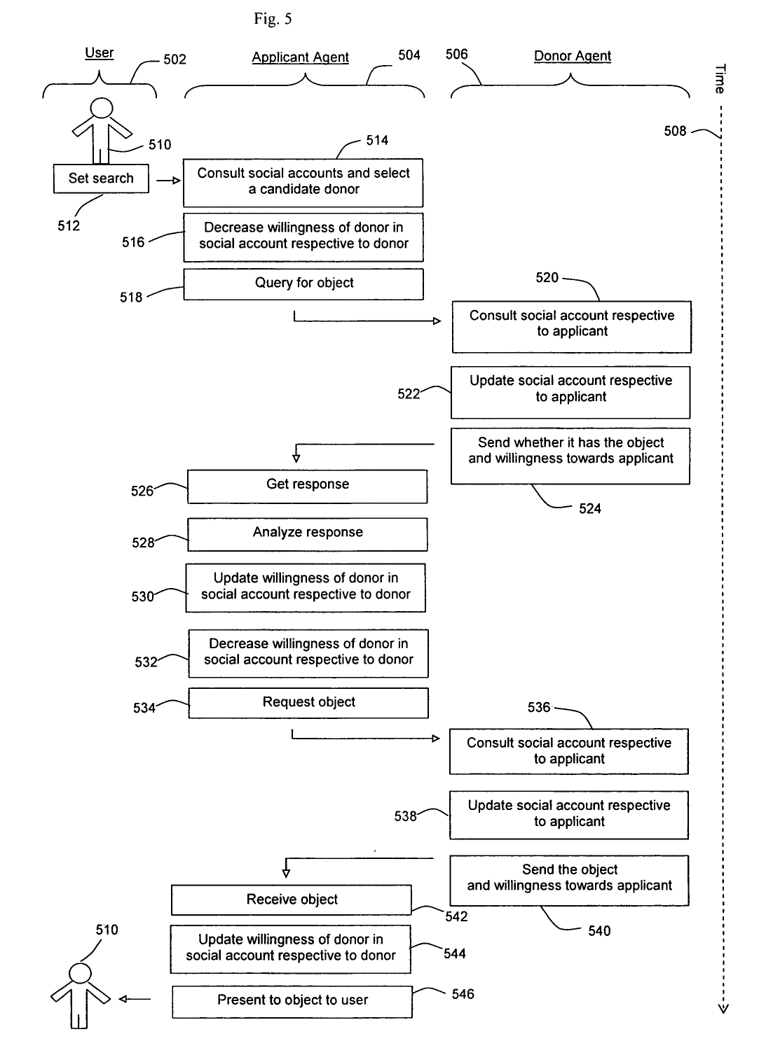

In exemplary embodiments of the invention, a donor that receives a query responds to the applicant notifying the applicant if the donor has the object. Optionally, the donor consults the social account respective to the applicant, and accordingly determines if to provide the object (or to point to its location). This operation is elaborated later on with respect to FIGS. 4 and 5.

Alternatively or alternatively, past queries and responses are kept at the applicant and/or donor peers, optionally at the respective social account, at least for a certain time. Optionally or alternatively, the information of past interactions are stored on a server, optionally of the cellular provider or the phone manufacturer. Consequently (optionally at later time, lower costs, etc.) peers are contacted based on that information, e.g. notified that a searched object was obtain and/or which peer has it. Optionally, other information relating to the interaction may be stored (e.g. battery capacity of a donor when the donor provided data), optionally at the respective social accounts, wherein they are used to determine a fairness and/or willingness degree of a donor to respond to an applicant and/or of an applicant to query a donor.

In exemplary embodiments of the invention, a positive response to a request is sending the object from a donor to an applicant, or informing that the donor has the object. An example of a negative response is informing that the donor does not has the object, or the donor declines to share it, or when the donor does not respond. Optionally, the donor does have the object but, for some self interest (e.g. to avoid superfluous queries), notifies the applicant that it does not have the object. Subsequent to negative responses, an applicant may try to get the object later on, and/or apply to other donors.

In exemplary embodiments of the invention, for example, in order to save costs, when an applicant queries a donor about data, the donor may send information about the data and/or its whereabouts, or refer the applicant to another donor which, for example, may be closer or has a cheaper program. Such an approach may be cost effective relative to sending the data (if the donor has it).

In exemplary embodiments of the invention, planned or random queries are performed

### Search Strategy

In exemplary embodiments of the invention, the search strategy is according to the following guidelines.
(a) Requesting an object from donors, giving precedence to donors that are likely to respond;
(b) If the object was received within a certain time limit the search finishes successfully;
(c) Else, requesting the object from donors which were not queried;
(d) If the object was received within a certain time limit the search finishes successfully;
(e) Else, the search fails; and
(f) The search is bounded by the number of donors an applicant may contact (avoiding overloading the group) and/or search costs.

In exemplary embodiments of the invention, a search strategy is tuned, or regulated, by parameters comprising (a) the maximal time an applicant waits for a response (time-out), denoted as ‘MaxT’, and (b) the maximal cost an applicant allows for searching for an object, denoted as ‘MaxC’. Optionally, MaxC is responsive to the number of messages required to query about the object. Optionally, MaxC is responsive to the number of messages required to obtain the object.

In exemplary embodiments of the invention, the search strategy is also tuned, or regulated by a parameter that limits the number of donors the applicant queries in a search, denoted as MaxP. The limit MaxP optionally prevents flooding the group (or a large portion thereof), avoiding adverse effects such as lowering the willingness donor to cooperate with the applicant due to consumption of their resources.

In exemplary embodiments of the invention, a peer owner supplies at least one of MaxT or MaxC or MaxP (e.g. via the agent UI). Optionally or alternatively, default values of a phone agent are used for MaxT or MaxC or MaxP. Optionally, MaxP is determined responsive to the group size and/or data objects merits. For example, if the group is large, MaxP may be larger than for a smaller group since a smaller proportion of the group is accessed, and many donors are available for subsequent searches. Also, if the object is popular, MaxP may be lower than if the object is not common since there is a good chance of finding the object among few donors. For example, MaxP is set as 50% of donors registered with an applicant and/or available for an applicant (e.g. via a service).

FIG. 4 illustrates a flowchart of a skeleton of a search strategy, in accordance with an exemplary embodiment of the invention.

Applicant agent determines MaxP (402), and obtains, or accesses, parameters MaxT and MaxC (404 and 406). Subsequently applicant agent consults its social accounts with respect to other peers (donors), determining a set of donors with high probability to respond to queries (408).

In exemplary embodiments of the invention, a probability is determined respective to estimated (as described above) or known willingness of a donor to cooperate (as described above) Optionally, the higher the willingness of a donor, the higher the probability of the donor to respond and/or provide the data object.

In exemplary embodiments of the invention, the probability is considered high if it exceeds a certain threshold wherein the threshold is optionally determined (at least initially) responsive to willingness degrees or the candidate peers, such as the average or median. Optionally, the threshold is determined according to past responses in data sharing.

If the set of high probability donors is not empty (410), applicant asks for the data object (412) from a donor (further details are given with respect with FIG. 5 below). Donors in the set are asked for data object (412) as long as there are donors in the high probability set (414) and the cost is lower then the limit MaxC (416).

If a data object was not received within MaxT (418), then an alternative set is tried, provided that MaxC was not exhausted (424).

In exemplary embodiments of the invention, the alternative set is selected from peers with lower probability than a certain level and/or unknown probability and/or with probability estimation that is not considered reliable (426). Optionally, the set is limited to MaxP donors less the number of donors which were already approached.

If the alternative set is not empty (428), then donors in the alternative set are asked for the data object (430), as long as there are donors in the alternative set (432) and the cost is lower than the limit MaxC (434).

Once the donors in the alternative set were asked about the data (430), applicant waits up to MaxT (436). If within MaxT data object was supplied (438), the search is finished successfully (422).

If data object was not received within MaxT (438), or the alternative set is empty (428), then the search fails (440).

The operation embedded in 412 and 430 (‘Ask donor for object’) is elaborated with respect to FIG. 5.

In exemplary embodiments of the invention, one of three search modes are used:

(a)‘FAST’ search, with low MaxT and high MaxC, so that fast response time is preferred, though with larger costs.

(b)‘CHEAP’ search, with high MaxT and low MaxC, so that low costs are, though with larger waiting time.

(c) ‘RAND’ search that picks up candidate donors in random and does not consider fairness, probabilities of donors nor limitations of cost and time (though some high time-out is in effect).

In exemplary embodiments of the invention, each of the search modes is limited to MaxP candidate donors at a time.

In exemplary embodiments of the invention, the settings of low or high MaxT and MaxC are provided by the user. Optionally or alternatively, MaxP or MaxC are determined from pre-set values in the applicant agent. Optionally or alternatively, the agent determines the values according to past performance. Optionally, MaxP and/or MaxC for FAST and/or CHEAP search are set (optionally by the owner, and optionally updated in operation), and the owner selects only the mode (FAST, CHEAP or RAND). Optionally, the agent determines the search mode, optionally according to the group size and/or costs program of the peer. Optionally, the values for MaxC and MaxP are determined by test runs or simulations.

In exemplary embodiments of the invention, other search modes are used, for example, relieving the constrains of MaxP and MaxC, so that all the donors are approached (‘brute force search’).

### Data Sharing Interaction

In exemplary embodiments of the invention, the data sharing strategy is according to the following guidelines.
(a) When an applicant queries a donor, the applicant increases the willingness towards the donor, and decreases the estimation of the willingness of the donor towards the applicant;
(b) When a donor receives a query for an applicant, the donor decreases its willingness towards the applicant, and increases the estimation of the willingness of the applicant towards the donor;
(c) When a donor sends an object to an applicant, the donor decreases its willingness towards the applicant, and increases the estimation of the willingness of the applicant towards the donor;
(d) When a an applicant receives an object from a donor, the applicant increases its willingness towards the donor, and decreases the estimation of donor willingness towards the applicant.

FIG. 5 schematically illustrates a time-line of events in an interaction for data sharing between peers, in accordance with an exemplary embodiment of the invention. The left column, titled ‘User’ (502), indicates the owner of a phone with an agent, titled ‘Applicant agent’ (504). The rightmost column, titled ‘Donor Agent’ (506), indicates a phone agent selected as a candidate to provide the data object. A dotted arrow titles ‘Time’ (508) indicates time flow reference for the charted events, and the bold arrows indicate direction of data flow.

The interaction illustrated in FIG. 5 is a general streamlined normal data sharing operation, and generally illustrate the process represented in the ‘Ask donor for Object’ operation of FIG. 4 (412 and 430). For example, when a donor has a searched object and the willingness degree towards an applicant is sufficient to send the object, the donor does not decline to provide the object, nor ‘cheat’ about the object (e.g. having it but not notifying the applicant). Similarly, exceptional cases such as timed out waits are not depicted for clarity reasons.

User 510 sets the keywords for the object search (512) and passes the search to applicant agent 504. Agent 504 consults its social account to determine a donor.

In exemplary embodiments of the invention, the donor is determined as described for FIG. 4.

Once donor 506 is determined, applicant agent 504 decreases in the social account respective to donor 506 the willingness of donor agent 506 to cooperate (516) and sends a query to donor agent 506 (518). The willingness degree of the donor is decreased since a query consumes some resources of donor 506, possibly reducing its willingness to cooperate.

In exemplary embodiments of the invention, reduction is by a constant such as 10% of the mid-value of willingness scale. Alternatively or alternatively, the reduction is responsive to other formulations such as 10% of the willingness degree. Optionally or alternatively, the reduction is responsive to past operation, for example, if a certain reduction was used and cooperation poor as only small number of donors were queried, a smaller reduction may be used, potentially increasing the number of candidate donor for the applicant. Typically, the willingness is reduced by a smaller amount relative to reduction due to receiving object (see below).

When donor agent 506 receives the query from applicant agent 504, donor agent 506 consults the social account with respect to applicant 504 to determine if to cooperate (520). If the willingness degree towards applicant 504 is sufficient to cooperate, donor agent 506 decreases in the social account respective to applicant 504 the willingness of donor agent 506 to cooperate (522) and sends to applicant agent 504 information comprising whether it has the requested object and, optionally, its willingness to cooperate with applicant agent 504 (524).

As donor 506 responds, applicant agent 504 receives the response (526), analyzes the response (528), and updates the willingness of donor agent 506 in the respective social account (530).

If donor agent 506 responded that it has the searched object, applicant agent 504 decreases in the social account respective to donor 506 the willingness of donor agent 506 to cooperate (532) and sends a request for the object to donor agent 506 (534). Typically, the reduction is larger than the reduction for a query, and, optionally, the reduction is responsive to the size of the data object and/or costs for donor 506 or its resources. Optionally, some of the information, such as object size, resource levels of donor phone costs to send it were sent in the response to the preceding query (524).

When donor agent 506 receives the request for the object from applicant agent 504, donor agent 506 consults the social account with respect to applicant 504 to determine if to cooperate (536). If the willingness degree towards applicant 504 is sufficient to send the object, donor agent 506 decreases in the social account respective to applicant 504 the willingness of donor agent 506 to further cooperation (538). Donor agent 506 sends to applicant agent 504 the searched object, and optionally, its willingness to further cooperate with applicant agent 504 (540).

In exemplary embodiments of the invention, the willingness reduction is responsive to the data object size and/or importance and/or transfer costs, as described regarding to willingness and cooperation factors above. For example, the willingness degree of donor 506 is reduced by 0.1% for each 1 K bytes sent, but not less then 10% and not larger than 80% (to charge for the data yet to preserve some willingness).

Applicant agent 504 receives the object from donor agent 506 (542), and updates the willingness of donor agent 506 in the respective social account (544). Finally, applicant agent 504 presents the data to the requesting user 510 (546).

In exemplary embodiments of the invention, sending requests and responses (e.g. 518, 524) and updating social accounts (e.g. 516, 522, respectively) may be performed in parallel. Optionally or alternatively, their order may be swapped, that is, sending precedes the update.

In exemplary embodiments of the invention, donor agent 506 may not respond to applicant agent. Optionally, donor 506 does not respond due to a low willingness degree, for example, donor agent 506 was unfairly loaded with requests, or its resources such as battery are scarce. Optionally, agent 506 responds after a time-out period from the query of applicant agent 504 (as described with respect to FIG. 4), for example, due to more demanding occupations.

Optionally, if donor 506 declines to respond, applicant agent 504 waits until a time-out and abandons, at least for a while, the interaction with donor 506. Optionally, after some time (e.g. starting with 1 minute and increasing the period if no response was received) applicant 504 increases donor 506 willingness in the social account with respect to donor 506, assuming it may now be more cooperative to applicant 504 since, for example, applicant 504 did not consume donor 506 resources for some time.

Using multi-stage interaction as described above allows flexibility and efficiency in time and/or bandwidth management. For example, buffering messages to be handled later rather then rejected or ignored when donor 506 is occupied with other activities.

In exemplary embodiments of the invention, when donor 506 does not have the data object, donor 506 records the request of applicant 504. Subsequently, when donor 506 obtains the data (or similar data, see above), it notifies applicant 504 about the data, raising willingness degree or fairness degree of applicant 504 towards donor 506, optionally the increase is larger than of regular cooperation as described above.

In exemplary embodiments of the invention, each message may be paired with an positive or negative acknowledgement from the other side (Ack/Nak) to ascertain a message was received. Optionally, other techniques for management of messages known in the art of communications may be employed.

### Exemplary Performance Results

It should be noted that, like other interacting systems, tuning operational parameters for the data sharing interaction (e.g. willingness reduction and increase) may be based on estimation and/or based on statistical analysis and/or simulations.

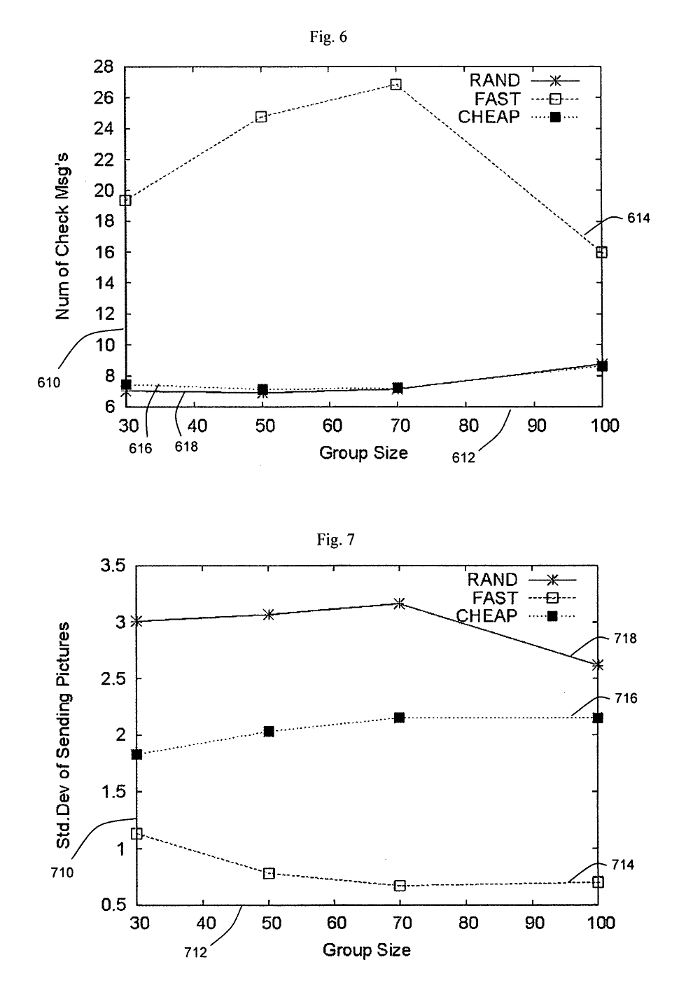

Exemplary methods as described above were executed in a simulation program. Some of the results are presented in FIG. 6 to 11.

Search modes FAST, CHEAP and RAND (see above) were simulated with conditions comprising the following:
1) Willingness of each peer towards another one is initialized to 10.
2) Estimation by an applicant of the willingness of a donor towards the applicant is initialized to 10.
3) When an applicant queries a donor, the applicant increases the willingness towards the donor by 0.1, and decreases the estimation of the willingness of the donor towards the applicant by 0.1; the donor decreases its willingness towards the applicant by 0.1 and increases the estimation of the willingness of the applicant towards the donor by 0.1.
4) When a donor sends data object to an applicant, the applicant increases its willingness towards the donor by 1+ object size (in MB), and decreases by 1 the estimation of donor willingness towards the applicant; the donor decreases its willingness towards the applicant by 1 and increases the estimation of the willingness of the applicant towards the donor by 1.
5) The experiments results are averaged over 30 sessions.

FIG. 6 illustrates the performance of FAST (614), CHEAP (616) and RAND (618) searches in terms of the number of query messages to obtain an object (related to cost) (610) with respect to the peers group size (612). The group comprised agents having a probability of 20% of possessing a data object of 4 MB.

It is apparent that FAST (614), being ‘expensive’ (high MaxC) and ‘impatient’ (low MaxT), requires more queries until an object is obtained within the short MaxT relative to the other searches. From a group size of about 70 and up FAST is less costly since (a) more donors are tried yielding higher probability of hits, and (b) more donors provide their willingness (and possibly other parameters) in response to the queries, so that the applicant has more information to identify high probabilities donors.

CHEAP and RAND, being patient (high MaxT) and waiting for responses from donors longer than FAST (that is, not quitting too early), obtain the data object with less queries and less cost. The long MaxT effects a similar performance of CHEAP and RAND (616 and 618).

FIG. 7 illustrates a fairness performance of FAST (714), CHEAP (716) and RAND (718) searches in terms of a distribution of peers (710) that shared data objects with respect to the peers group size (712). The group comprised agents having a probability of 20% of possessing a data object of 4 MB.

The distributions of the searches, expressed as the standard deviation of donors supplying the data object, reflect the fairness of exploiting the donors. The lower the distribution the more uniformly (fairly) the donors were treated.

FAST (714) is the fairest among the searches as it is ready to bear the costs of many trials among many donors (high MaxC) but does not wait for non-willing donors (low MaxT).

CHEAP (716) is less fair than FAST as it send messages to a smaller set of donors (exploiting them), consequently reducing their willingness for subsequent cooperation.

RAND (718) is less fair than the other two searches since it does not take into account the probabilities of the prospect donors, so it may query (and possibly repeatedly) unwilling donors. Yet, for a large group, randomization reduces the unfairness since the likelihood of requesting (and possibly repeated) a particular donor is small, as is demonstrated in the reduction of the distribution of RAND from a group size of about 70 and upwards.

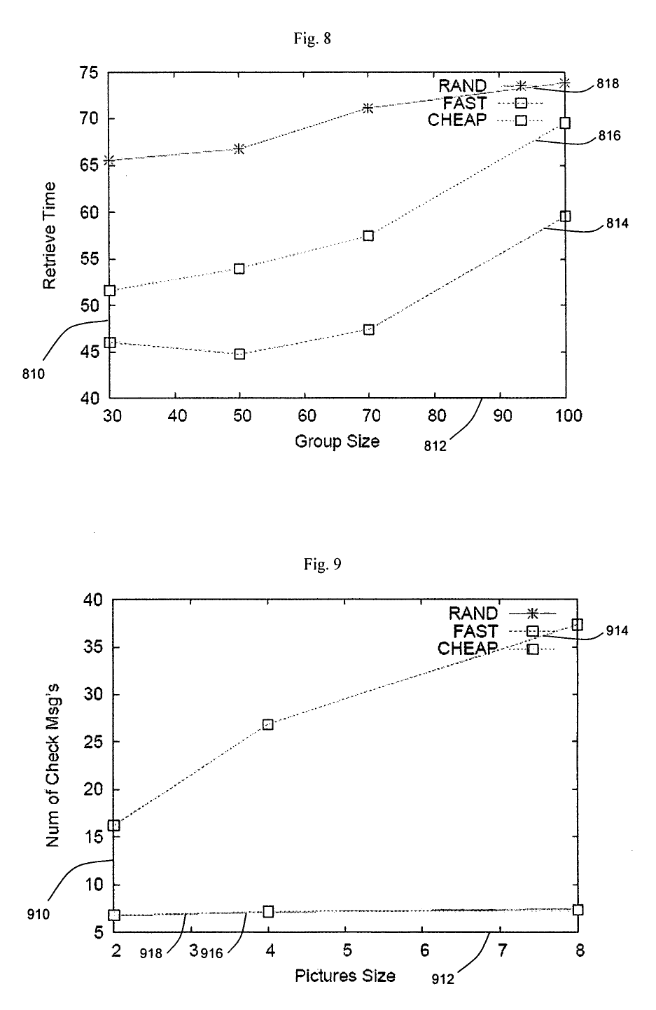

FIG. 8 illustrates time performance of FAST (814), CHEAP (816) and RAND (818) searches in terms of object retrieve time in seconds (810) as a function of the peer group size (812). The group comprised agents having a probability of 20% of possessing a data object of 4 MB.

Comparing the results illustrated in FIGS. 7 and 8 it can be recognized that there is a correlation between the fairness as illustrated in FIG. 7 and the retrieve time of FIG. 8. FAST (814), being fair, benefits from willing donors even within the short time-out (low MaxT). CHEAP (816), being less fair than FAST, waits longer (high MaxT) to retrieve objects from less willing donors. RAND, being the least fair, waits longer for loaded or unwilling donors, but can afford to wait (long time-out).

FIG. 9 illustrates the performance of FAST (914), CHEAP (916) and RAND (918) searches in terms of the number of query messages (related to cost) (910) with respect to the data object size (912) in MB. The group comprised 70 agents having a probability of 20% of possessing the data object.

FAST (914) has to query many donors till a responsive donor is found within the small time-out (low MaxT), and the responsiveness relates to donor load in terms of object size, hence the quasi-linear relation to the size of the object. On the other hand, CHEAP (916) and RAND (918) query fewer donors but can wait for a long time (high MaxT) until a donor (even a busy one) responds positively, so the number of queries required to obtain an object is similar for these modes and is not related to the object size (donor transmission time), as apparent in their similar behavior.

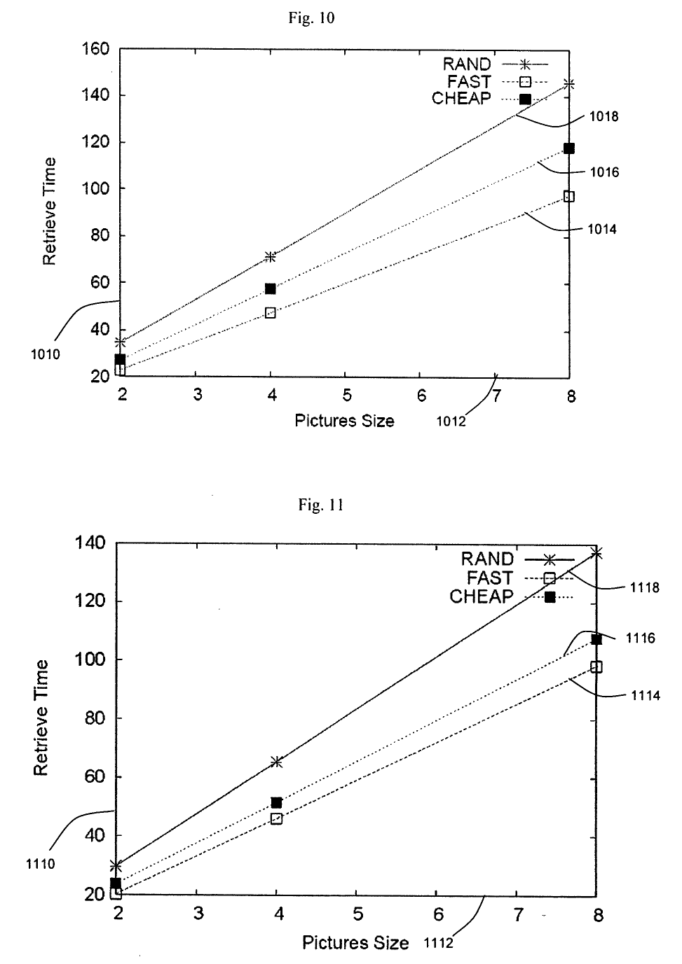

FIG. 10 illustrates the performance of FAST (1014), CHEAP (1016) and RAND (1018) searches in terms of object retrieve time in seconds (1010) with respect to the data object size (1012) in MB. The group comprised 70 agents having a probability of 20% of possessing the data object.

All searches exhibits linear dependency on the object size since it takes more time to send larger objects. FAST (1014), being fairest, gets responses faster then CHEAP (1016), and RAND (1018) which does not regards fairness, is the slowest in getting responses.

The searches behave similarly in small groups as can be seen in FIG. 11.

FIG. 11 illustrates the performance of FAST (1114), CHEAP (1116) and RAND (1118) searches in terms of object retrieve time in seconds (1110) with respect to the data object size (1112) in MB. The group comprised 30 agents having a probability of 20% of possessing the data object.

FAST and CHEAP, being fair, do not show much difference since the group is small and they apply approximately to the same donors. RAND, not being fair, may query unwilling donors and therefore experiences delayed responses.

### Discussion

The exemplary simulations indicate that the FAST search mode is typically fairer and faster than the other modes, though on the expense of higher costs. Therefore, the owner or a peer (or a peer agent) should decide which mode is preferred under particular circumstances. For example, if the object is highly required (e.g. a business item) the owner may pay more in order to retrieve it soon. On the other hand, for example, a family member may wait longer to obtain a picture from a family event saving expenses.

### Revenue (General Discussion)

In exemplary embodiments of the invention, an opportunity to get revenue comprises a motivation (i.e. self interest) to participate in the group and cooperate in data sharing (in addition to other benefits such as to obtain a required object). For example, a peer may dedicate some of the peer's (possibly scarce) memory capacity to store data for sharing only the peer obtains some revenue. For example, for each data item and/or according to the volume of the data that a peer stores and/or shares, the peer gets some payment or refund in the peer cellular company account. Optionally or alternatively, a donor providing data may charge the applicant for the service. The charge may be, for example, by crediting the donors' cellular account. Optionally or alternatively, the payment may be responsive to the merits or size of the data it provides. Optionally or alternatively, a peer may dedicate a larger size of memory for data, and/or increase its willingness degree responsive to the payment it obtains for its resources usage.

In exemplary embodiments of the invention, the telephone manufacturer a the service provider may obtain revenues by supplying the peer model agent, either by loading the agent to the peer and/or enabling it to perform on the peer and/or executing the agent, at least partly, on the manufacturer or service facilities (e.g. server).

In exemplary embodiments of the invention, the cellular telephone company and/or a communication service, which provides the communications infrastructure and message forwarding services, may take part in the revenues. Optionally, the cellular company (or other service provider), either that of an applicant and/or a donor, may charge a percentage of revenues of the peers so that the cellular company has a motivation to supply the services for message forwarding and/or facilities to support the group, for example, providing locality of peers. Optionally or alternatively, a service (e.g. cellular company, or manufacturer company) may supply a server for the peers group organization (e.g. a list contacts numbers) and/or caching of operational data such as query and results history (as discussed before). For this service the company may charge a payment for each message or for a volume of exchanged messages (e.g. charging the bank accounts of the respective applicant and donor). Since a cellular company may profit from the interaction operation, it may compensate peers that interact more extensively than other peers by allowing them benefits, such as broader bandwidth or reduced charges, to motivate them to interact and share data (and pay the company).

In exemplary embodiments of the invention, when a peer obtains revenue such as by allocating resources for the group operation (e.g. data space, message routing) the peer (on behalf of the owner) may wish to increase the revenue. The peer manufacturer and/or the service provider may give that peer (e.g. by downloading or enablement) upgraded versions of the agent that allow larger memory capacity for data and/or processor time allocation, in return for a payment or participation in the revenues.

In exemplary embodiments of the invention, since the cellular company may profit from the group interaction, it may enhance the group operation by providing more services, possibly for a charge. For example, it may provide locality information so that an applicant may query (optionally in addition to textual queries) about the locality of potential donors so that it may obtain the data from close by peers for less expensive communications (e.g. without roaming).

In exemplary embodiments of the invention, a peer may donate, to some extent at least, resources such as memory capacity and performance free of charge. Optionally, the will is in order to motivate others to reciprocate with additional capacity and performance. Optionally or alternatively, a peer may allocate more resources when communication cost is low such as at night or weekend. Optionally or alternatively, it may donate resources until some overhead level, beyond which it may charge. Optionally or alternatively, the charge may be responsive to the overhead, the higher the overhead, the higher the price. Optionally or alternatively, beyond a certain overhead no extra charge is demanded.

In exemplary embodiments of the invention, a peer may reserve resources such as memory for data in at least two partitions, where each partition imposes a different price tag. Optionally or alternatively, one partition is free of charge, for example, to motivate others to donate some resources for the benefit of the group.

In exemplary embodiments of the invention, some peers may be connected in the group for a long time relative to others. The more permanent peers may encounter more traffic for queries and search for objects that they may have. Such peers may, due to cost consideration and performance overhead, ignore incoming traffic effecting possibly some degradation of the group performance. One the other hand, optionally, such peers may cooperate if extra charge is paid by applicants.

### Exemplary Resources of Cellular Phones or Handsets

In exemplary embodiments of the invention, cellular phones are used as the peers.

Typically, cellular phones have limited resources. Following are typical numbers, which are expected to get better as technology improves (optionally paired with more demand on the peers such as data volume and transfer rate).

For example, memory is typically in range of a 16-128 KB of RAM and 1-50 MB for storable memory. Some phones allow optional additional memory cards to increases the capacity (e.g., 1-4 GB) but the access time is can be longer than the regular memory, so it may affect the performance and consumes more battery resources.

The processor in cellular phones is typically a low performance RISC or other architecture, designed to preserve the battery life on expense of performance.

In many telephones, very low resources are available during a telephone conversation or during a media capture operation, to carry out other tasks.

Battery life is typically about 6 to 24 hours in regularly used telephones.

The communication bandwidth is typically several hundreds of thousands of bits per second up to 1-3 millions of bits per second. For lower grade telephones, the transmission rate may be in the tens of thousands of bits per second. Also, significant delay times may exist.

The resources of cellular phones or handsets is expected to grow as technology progress. However, the load of activities such as data sharing is expected to grow accordingly.

### General

In the description and claims of the present application, each of the verbs “comprise”, “include” and “have” as well as any conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to necessarily limit the scope of the invention. In particular, numerical values may be higher or lower than ranges of numbers set forth above and still be within the scope of the invention. The described embodiments comprise different features, not all of which are required in all embodiments of the invention. Some embodiments of the invention utilize only some of the features or possible combinations of the features. Alternatively and additionally, portions of the invention described/depicted as a single unit may reside in two or more separate physical entities which act in concert to perform the described/depicted function. Alternatively and additionally, portions of the invention described/depicted as two or more separate physical entities may be integrated into a single physical entity to perform the described/depicted function. Variations of embodiments of the present invention that are described and embodiments of the present invention comprising different combinations of features noted in the described embodiments can be combined in all possible combinations including, but not limited to use of features described in the context of one embodiment in the context of any other embodiment. The scope of the invention is limited only by the following claims.

All publications and/or patents and/or product descriptions cited in this document are fully incorporated herein by reference to the same extent as if each had been individually incorporated herein by reference or if they were reproduced in full herein.

1. A method for cooperation between mobile devices peers representing social relations of the owners of the peers, comprising:
(a) providing a plurality of peers in a network; and
(b) cooperating in a manner which utilizes resources of the devices responsive to the social relations.

2. A method according to claim 1, wherein cooperation comprises data sharing or interaction for data sharing.

3. A method according to claim 1, wherein the social relations comprise symmetric or hierarchical relations with respect to one or more peers.

4. A method according to claim 1, wherein the social relations comprise one or both of static and dynamic relations with respect to one or more peers.

5. A method according to claim 1, wherein representing social relations comprises modeling at least part of the social relation or interaction or cooperation for data sharing.

6. A method according to claim 5, wherein the model comprises at least one or more of rules, parameters or actions affecting the cooperation or data sharing.

7. A method according to claim 5, wherein modeling is responsive to the social relations of the peers owners.

8. A method according to claim 6, wherein the one or more parameters represent at least a fairness degree or a willingness degree to provide data to one or more peers or to request data from one or more peers.

9. A method according to claim 6, wherein the one or more parameters represent a social hierarchy respective to one or more peers.

10. A method according to claim 8, wherein the fairness degree or the willingness degree is responsive to the social hierarchy degree with respect to one or more peers.

11. A method according to claim 6, wherein the at least one of the one or more parameters is modified responsive to the data sharing or cooperation.

12. A method according to claim 11, wherein the willingness degree or fairness degree comprises an estimated willingness degree or fairness degree of one or more peers to provide data to the peer.

13. A method according to claim 11, wherein the willingness degree or fairness degree is obtained from one or more peers.

14. A method according to claim 8, wherein the fairness degree or willingness degree of a peer respective to one or more peers is adapted to achieve cooperation between the peers.

15. A method according claim 6, wherein one or more parameters of a first peer model pertaining to a second peer are grouped as a social account of the first peer with respect to the second peer.

16. A method according to claim 6, comprising setting at least one of said parameters by a owner of a device.

17. A method according to claim 6 comprising setting at least one of said parameters by the peer model.

18. A method according to claim 5, comprising modifying the modeled social relations responsive to a data sharing or cooperation between the peers.

19. A method according to claim 18, wherein modifying comprises modifying at least one of the rules or parameters or actions.

20. A method according to claim 18, wherein the modification is responsive to at least one of receiving data, providing data, amount of received or provided data, the merits of data received or provided data, resources utilization in providing data, costs of providing data, revenues obtained in providing data, available resources when providing data or providing information about the data.

21. A method according to claim 20, wherein the data merits are responsive to at least one of the data volume, importance, abundance, popularity, distribution among peers, sharing frequency or count, date or age, age rating, contents, or type of the data.

22. A method according to claim 5, wherein the model is implemented, at least partially, by a computerized agent.

23. A method according to claim 22, wherein the agent comprises a program.

24. A method according to claim 22, wherein the agent comprises at least one of memory, hardware, firmware or processor of the device.

25. A method according to claim 22, wherein the agent comprises at least one of add-on memory, hardware or firmware or processor.

26. A method according to claim 22, wherein the agent initiates or affects communications of a device with one or more devices.

27. A method according to claim 2, wherein cooperation or sharing data comprises consuming resources of a peer device that is larger than, or approximately about, the load of other operations of the device.

28. A method according to claim 27, wherein the resources of the device comprise least one of memory, energy, computing power, bandwidth or communications costs.

29. A method according to claim 1, wherein a mobile device comprises a cellular phone or cellular handset or wireless handset or a cellular component or a wireless component.

30. A method according to claim 1, wherein the peers comprise a group characterized by identifications unique to each peer and shared by the peers.

31. A method according to claim 30, wherein a first peer stores the identification of a second peer in the first peer memory or in another device accessible by the first peer.

32. A method according to claim 30, wherein a peer identification is used to contact the respective peer by another peer.

33. A method according to claim 30, wherein each peer in the group can contact all other peers the group.

34. A method according to claim 30, wherein the identification is one of a phone number, or name of a peer, or a peer code, or name or part of name of the peer owner, or a nickname of the peer owner, or the peer SIM number or the peer IP number, or MAC number of a device.

35. A method according to claim 15, wherein data is shared with a first peer responsive to a search by the first peer, comprising:
(a) determining one or more candidate peers according to the social account of the first peer respective to the candidate peers; and
(b) requesting data from at least one of the candidate peers.

36. A method according to claim 35, wherein determining comprises determining peers according to the willingness degree or fairness degree of a candidate peer to share data with the first peer.

37. A method according to claim 35, wherein the candidate peers are limited according to at least one parameter comprised in the first peer model or agent.

38. A method according to claim 35, wherein requesting data comprises:
(a) querying at least one of the candidate peers whether the candidate peer has the data;
(b) waiting for a response from at least one of the candidate peers;
(c) requesting the data from a candidate peer that responded that it has the data; and
(d) receiving the data from at least one of the candidate peers.

39. A method according to claim 38, wherein having the data comprises possessing the data, or having access to the data, or having the location of the data.

40. A method according to claim 35, wherein requesting data comprises requesting a location of the data.

41. A method according to claim 38, wherein querying or requesting the at least one the candidate peer is determined according to a cost of a query or request.

42. A method according to claim 41, wherein the cost is responsive to the number of messages sent to query about or request the data.

43. A method according to claim 38, wherein waiting is limited according to at least one parameter comprised in the first peer model or agent.

44. A method according to claim 38, wherein querying a candidate peer comprises increasing the willingness degree or the fairness degree of the first peer with respect to the candidate peer.

45. A method according to claim 38, wherein querying a candidate peer comprises decreasing the willingness degree or the fairness degree of the candidate peer with respect to the first peer.

46. A method according to claim 38, wherein receiving the data comprises increasing the willingness degree or the fairness degree of the first peer with respect to the at least one candidate peer.

47. A method according to claim 38, wherein receiving the data comprises decreasing the willingness degree or the fairness degree of the at least one candidate peer with respect to the first peer.

48. A method according to claim 46, wherein increasing or decreasing is responsive to one or more of the size of the data, or merits of the data, or resources utilization in providing the data, or costs of providing data, or revenues obtained in providing data, or available resources in providing data.

49. A method according to claim 38, wherein receiving the data is limited by a time period according to at least one parameter comprised in the first peer model or agent.

50. A method for modeling cooperating mobile devices peers, comprising:
(a) providing a plurality of peers in a network; and
(b) modeling the cooperation of one peer by another peer.

51. A method according to claim 7, wherein modeling comprises at least one or more of rules, parameters or actions affecting the cooperation.
